(19) United States
(12) Patent Application Publication
(10) Pub. No.: US 2026/0260299 A1
(43) Pub. Date: Sep. 3, 2026

(54) AUTHENTICATED VOUCHER DISTRIBUTION, DISTRIBUTION UPON TRIGGERING EVENT AND TRUST DISTRIBUTION USING BLOCKCHAIN

(71) Applicant: WILLPORT HOLDINGS, INC., Las Vegas, NV (US)

(72) Inventor: Doris H. SCHWARTZ, Las Vegas, NV (US)

(73) Assignee: WILLPORT HOLDINGS, INC., Las Vegas, NV (US)

(21) Appl. No.: 19/407,461

(22) Filed: Dec. 3, 2025

Related U.S. Application Data
(63) Continuation of application No. 18/633,594, filed on Apr. 12, 2024, now abandoned.
Application No. 18/633,594 is a continuation of application No. 18/171,353, filed on Feb. 19, 2023, now abandoned.
Application No. 18/171,353 is a continuation of application No. 17/097,131, filed on Nov. 13, 2020, now abandoned.
Application No. 18/633,594 is a continuation of application No. 18/169,922, filed on Feb. 16, 2023, now abandoned.
Application No. 18/169,922 is a continuation of application No. 17/097,364, filed on Nov. 13, 2020, now abandoned.
Application No. 18/633,594 is a continuation of application No. 18/164,589, filed on Feb. 5, 2023, now abandoned.
Application No. 18/164,589 is a continuation of application No. 17/097,279, filed on Nov. 13, 2020, now abandoned.
(60) Provisional application No. 62/937,127, filed on Nov. 18, 2019.
(60) Provisional application No. 62/937,127, filed on Nov. 18, 2019.
(60) Provisional application No. 62/937,127, filed on Nov. 18, 2019.
(60) Provisional application No. 62/939,181, filed on Nov. 22, 2019.
(60) Provisional application No. 62/939,189, filed on Nov. 22, 2019.
(60) Provisional application No. 62/947,723, filed on Dec. 13, 2019.

(51) Int. Cl. G06Q 40/12; H04L 9/32

(52) U.S. Cl. CPC G06Q 40/12; H04L 9/32

(57) ABSTRACT

Disclosed are systems and methods for receiving an initiation request associated with a voucher to be transferred from a first user and a second user or a trust distribution, wherein the voucher or trust is initiated by the first user, initiating a voucher or trust.

### CROSS-REFERENCE

This application is a continuation of application of Ser. No. 18/633,594 filed Apr. 24, 2024, which was a continuation of Ser. No. 18/171,353 filed Feb. 19, 2023, which was a continuation of application Ser. No. 17/097,131 filed Nov. 13, 2020, which claimed the benefit of U.S. Provisional Application No. 62/937,127, filed Nov. 18, 2019, entitled Authenticated Voucher for Distribution of Funds Upon Occurrence of a Triggering Event Using Blockchain, and U.S. Provisional Application No. 62/939,181, filed Nov. 22, 2019, entitled Authenticated Voucher for Distribution of Funds Using Blockchain, which applications are incorporated herein in their entirety by reference.

Application Ser. No. 18/171,353 filed Feb. 19, 2023, was also a continuation of application Ser. No. 18/164,589 filed Feb. 5, 2023, which is a continuation of application Ser. No. 17/097,279 filed Nov. 13, 2020, which claims the benefit of U.S. Provisional Application No. 62/937,127, filed Nov. 18, 2019, entitled Authenticated Voucher for Distribution of Funds Upon Occurrence of a Triggering Event Using Blockchain, and U.S. Provisional Application No. 62/939,189, filed Nov. 22, 2019, entitled Authenticated Voucher for Distribution of Funds Upon Occurrence of a Triggering Event Using Blockchain, which applications are incorporated herein in its entirety by reference.

Application Ser. No. 18/171,353 filed Feb. 19, 2023, was also a continuation of Ser. No. 18/169,922 filed Feb. 16, 2023, which is a continuation of U.S. application of Ser. No. 17/097,364 filed Nov. 13, 2020, which claims the benefit of U.S. Provisional Application No. 62/937,127, filed Nov. 18, 2019, entitled Authenticated Voucher for Distribution of Funds Upon Occurrence of a Triggering Event Using Blockchain, and U.S. Provisional Application No. 62/947,723, filed Dec. 13, 2019, entitled Authenticated Distribution of Funds Upon Occurrence of a Triggering Event Using Blockchain, which applications are incorporated herein in its entirety by reference.

### BACKGROUND

Young people today are facing a savings deficit. In fact, 67% of young millennials (between 18 and 24) and 61% of older millennials (between 25 and 34) have less than $1,000 in savings. Lack of savings and lack of developing good habits related to savings early in life can have a long-term impact on wealth. Those who don't save are unlikely to be wealthy in the future. Young people spend their money on food delivery, travel and their social life. This youth saving trend causes concern for parents, grandparents, aunts and uncles.

Even if some money is directed towards savings, young people often do not have a relationship with an advisor who can guide them in their investing strategy to ensure they are on a path for success later in life.

Additionally, in some relationships one person takes on the primary role of managing the finances. In the event of an illness the spouse or partner may feel ill-equipped to take over the responsibility for managing the finances.

What is needed is a way to provide funds to a young person upon the occurrence of an event that establishes an initial relationship for a minimum period of time with an advisor. What is also needed is a way to provide restricted funds to a person who could benefit from coaching and oversight of financial management.

What is needed is a way to provide funds to a young person via a trust. Further what is needed is a way to provide funds via a trust that establishes an initial relationship with an advisor.

### SUMMARY

Disclosed are systems and methods for administering a voucher. The system provides for the electronic transfer of a voucher followed by the transfer of money at a present or future date, using a comprehensive and secure time forward delivery system. The systems and methods are configurable to be integratable into a financial or insurance institution's existing digital delivery framework or configurable to operate as a stand-alone platform. Integrity of the voucher system can be provided with the use of, for example, blockchain and/or biometric data.

An aspect of the disclosure is directed to blockchain voucher systems. Systems comprise: at least one hardware processor; and a memory storing instructions that, when executed by the at least one hardware processor, causes the at least one hardware processor to perform operations in a networked computing environment comprising: receiving a request to create a voucher from a requestor; creating a voucher blockchain; obtaining recipient information from the requestor; appending the recipient information to a voucher blockchain; obtaining one or more voucher source information from the requestor; appending the one or more voucher source information to the voucher blockchain; obtaining an advisor information from the requestor; appending the advisor information to the voucher blockchain; generating the voucher wherein the voucher comprises a control logic configured to control access to the voucher based on obtaining verification of the recipient, instructions from the recipient, and instructions from the advisor and the control logic is executed using the hardware processor configured to receive a first instruction from the recipient to open an account and a second instruction from the advisor to open an account; and appending the voucher to the voucher blockchain. The systems can include one or more instructions comprising: obtaining a marital status from the requestor; obtaining spousal information from the requestor; obtaining spousal agreement from a spouse; confirming the marital status; generating a marital status completion block; and appending the marital status completion block to the voucher blockchain. Additionally, the systems can include one or more instructions comprising: obtaining a personalization input from the requestor for the one or more recipients; generating a personalization completion block; and uploading the personalization completion block to the voucher blockchain. In still other configurations, the systems can include one or more instructions comprising: creating a voucher agreement; creating an account set-up form; creating a management agreement; creating an account transfer form; creating a margin agreement; creating an options agreement; creating a money movement agreement; generating a voucher documents completion block containing the one or more created forms ad agreements; and appending the voucher documents completion block to the voucher blockchain. The system can also be configured to generate a unique hash value for each of the documents reviewed and signed based on a secure hash algorithm in real time and store each unique hash value on the voucher blockchain. Additional instructions can include notifying the recipient of the voucher; registering the voucher by the recipient; obtaining an approval of redemption documents from the recipient; generating a voucher delivery completion block; and appending the voucher delivery completion block to the voucher blockchain. Redemption documents can include one or more of: recipient account set-up; management agreement; account transfer form; margin agreement; options agreement; and move money agreement. Instructions can further comprise one or more of: providing an instruction for a coaching amount; providing an instruction for coaching terms; generating a coaching voucher delivery block; and appending the coaching voucher delivery completion block to the voucher blockchain. Moreover, the instructions can also further comprise one or more of: analyzing an instruction from a recipient; providing the recipient feedback on the instruction; generating a coaching transaction block and appending the coaching transaction block to the voucher blockchain. The system is also configuration to provide recipient feedback at a plurality of times. The system can also be configure to obtain one or more verification contact information for the recipient; and/or appending the verification contact information to the voucher blockchain.

Another aspect of the disclosure is directed to computer-implemented methods for account creation in a networked computing environment. The method comprise: receiving a request to create a voucher from a requestor; creating a voucher blockchain; obtaining recipient information from the requestor; appending the recipient information to a voucher blockchain; obtaining one or more verification contact information for the recipient; appending the one or more voucher source information to the voucher blockchain; obtaining an advisor information from the requestor; appending the advisor information to the voucher blockchain; generating the voucher wherein the voucher comprises a control logic configured to control access to the voucher based on obtaining verification of the recipient, instructions from the recipient, and instructions from the advisor and the control logic is executed using the hardware processor configured to receive a first instruction from the recipient to open an account and a second instruction from the advisor to open an account; and appending the voucher to the voucher blockchain. The methods can include one or more instructions comprising: obtaining a marital status from the requestor; obtaining spousal information from the requestor; obtaining spousal agreement from a spouse; confirming the marital status; generating a marital status completion block; and appending the marital status completion block to the voucher blockchain. Additionally, the methods can include one or more instructions comprising: obtaining a personalization input from the requestor for the one or more recipients; generating a personalization completion block; and uploading the personalization completion block to the voucher blockchain. In still other configurations, the methods can include one or more instructions comprising: creating a voucher agreement; creating an account set-up form; creating a management agreement; creating an account transfer form; creating a margin agreement; creating an options agreement; creating a money movement agreement; generating a voucher documents completion block containing the one or more created forms ad agreements; and appending the voucher documents completion block to the voucher blockchain. The system can also be configured to generate a unique hash value for each of the documents reviewed and signed based on a secure hash algorithm in real time and store each unique hash value on the voucher blockchain. Additional instructions can include notifying the recipient of the voucher; registering the voucher by the recipient; obtaining an approval of redemption documents from the recipient; generating a voucher delivery completion block; and appending the voucher delivery completion block to the voucher blockchain. Redemption documents can include one or more of: recipient account set-up; management agreement; account transfer form; margin agreement; options agreement; and move money agreement. Instructions can further comprise one or more of: providing an instruction for a coaching amount; providing an instruction for coaching terms; generating a coaching voucher delivery block; and appending the coaching voucher delivery completion block to the voucher blockchain. Moreover, the instructions can also further comprise one or more of: analyzing an instruction from a recipient; providing the recipient feedback on the instruction; generating a coaching transaction block and appending the coaching transaction block to the voucher blockchain. The system is also configuration to provide recipient feedback at a plurality of times. The system can also be configure to obtain one or more verification contact information for the recipient; and/or appending the verification contact information to the voucher blockchain.

Disclosed are systems and methods for administering funds in a trust via a distribution system. The system provides for the electronic transfer at a present or future date using a comprehensive and secure delivery system. The systems and methods are configurable to be integratable into a financial or insurance institution's existing digital delivery framework or configurable to operate as a separate networked platform. Integrity of the distribution system can be provided with the use of, for example, blockchain and/or biometric data. The distribution can be contingent for a period of time.

An aspect of the disclosure is directed to systems comprising: at least one hardware processor; and a memory storing instructions that, when executed by the at least one hardware processor, causes the at least one hardware processor to perform operations in a networked computing environment comprising: receiving a request to create a distribution from a requestor; creating a distribution blockchain; obtaining recipient information from the requestor; appending the recipient information to a distribution blockchain; obtaining one or more distribution source information from the requestor; appending the one or more distribution source information to the voucher blockchain; obtaining a condition for distribution from the requestor; appending the condition for the distribution to the distribution blockchain; obtaining an advisor information from the requestor; appending the advisor information to the distribution blockchain; generating the distribution wherein the distribution comprises a control logic configured to control access to the distribution based on obtaining verification of the condition for distribution and the control logic is executed using the hardware processor configured to receive a first instruction from the recipient to open an account and a second instruction from the advisor to open an account; and appending the distribution to the distribution blockchain. Additionally, the systems can include the instructions further comprising one or more of: obtaining a marital status from the requestor; obtaining spousal information from the requestor; obtaining spousal agreement from a spouse; confirming the marital status; generating a marital status completion block; and appending the marital status completion block to the voucher blockchain. The instructions can further comprise one or more of: obtaining a personalization input from the requestor for the one or more recipients; generating a personalization completion block; and uploading the personalization completion block to the voucher blockchain. In at least some configurations, the instructions further comprise: obtaining a term for the distribution from the requestor; and appending the term of the distribution to the distribution blockchain. Additional instructions can include one or more of: creating a distribution agreement; creating an account set-up form; creating a management agreement; creating an account transfer form; creating a margin agreement; creating an options agreement; creating a money movement agreement; generating a distribution documents completion block containing the one or more created forms and agreements; and appending the distribution documents completion block to the distribution blockchain. Unique hash values can be created for each of the documents reviewed and signed based on a secure hash algorithm in real time and store each unique hash value on the distribution blockchain. Additionally, the system can be configured to further comprise one or more of: notifying the recipient of the distribution; registering the distribution by the recipient; obtaining an approval of redemption documents from the recipient; generating a distribution delivery completion block; and appending the distribution delivery completion block to the distribution blockchain.

Another aspect of the disclosure is directed to computer-implemented methods for account creation in a networked computing environment, the method comprising: receiving a request to create a distribution from a requestor; creating a distribution blockchain; obtaining recipient information from the requestor; appending the recipient information to a distribution blockchain; obtaining one or more distribution source information from the requestor; appending the one or more distribution source information to the voucher blockchain; obtaining a condition for distribution from the requestor; appending the condition for the distribution to the distribution blockchain; obtaining an advisor information from the requestor; appending the advisor information to the distribution blockchain; generating the distribution wherein the distribution comprises a control logic configured to control access to the distribution based on obtaining verification of the condition for distribution and the control logic is executed using the hardware processor configured to receive a first instruction from the recipient to open an account and a second instruction from the advisor to open an account; and appending the distribution to the distribution blockchain. Additionally, the methods can include the instructions further comprising one or more of: obtaining a marital status from the requestor; obtaining spousal information from the requestor; obtaining spousal agreement from a spouse; confirming the marital status; generating a marital status completion block; and appending the marital status completion block to the voucher blockchain. The instructions can further comprise one or more of: obtaining a personalization input from the requestor for the one or more recipients; generating a personalization completion block; and uploading the personalization completion block to the voucher blockchain. In at least some configurations, the instructions further comprise: obtaining a term for the distribution from the requestor; and appending the term of the distribution to the distribution blockchain. Additional instructions can include one or more of: creating a distribution agreement; creating an account set-up form; creating a management agreement; creating an account transfer form; creating a margin agreement; creating an options agreement; creating a money movement agreement; generating a distribution documents completion block containing the one or more created forms and agreements; and appending the distribution documents completion block to the distribution blockchain. Unique hash values can be created for each of the documents reviewed and signed based on a secure hash algorithm in real time and store each unique hash value on the distribution blockchain. Additionally, the method can be configured to further comprise one or more of: notifying the recipient of the distribution; registering the distribution by the recipient; obtaining an approval of redemption documents from the recipient; generating a distribution delivery completion block; and appending the distribution delivery completion block to the distribution blockchain receiving a request to create a distribution from a requestor.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
U.S. Pat. No. 5,878,140 A to Chaum issued Mar. 2, 1999 for Limited-Traceability Systems;
U.S. Pat. No. 9,342,831 B1 to Davis issued May 17, 2016 for Facilitating Same Day Payment Transactions;
U.S. Pat. No. 9,342,741 B2 to Amtrup issued May 17, 2016, for Systems, Methods and Computer Program Products for Determining Document Validity;
U.S. Pat. No. 10,142,347 B2 to Kurian issued Nov. 27, 2018, for System for Centralized Control of Secure Access to Process Data Networks;
U.S. Pat. No. 10,164,779 B2 to Uhr et al., issued Dec. 25, 2018, for System for Issuing Public Certificate on Basis of Block chain, and Method for Issuing Public Certificate on Basis of Block chain by Using Same;
U.S. Pat. No. 10,331,868 B2 to Park issued Jun. 25, 2019, for User Authentication Method and System Using Variable Keypad and Biometric Identification;
U.S. Pat. No. 10,332,115 B2 to Donovan et al., issued Jun. 25, 2019, for Systems and Methods for Processing Metadata Statements in Payment Flows;
U.S. Pat. No. 10,798,094 B2 to Wei issued Oct. 6, 2020, for Blockchain-based account management;
U.S. Pat. No. 10,798,180 B1 to Gracey et al. issued Oct. 6, 2020 for Systems And Methods For Optimizing Information Collaboration; and
US 2019/0005470 A1 to Uhr, et al., published Jan. 3, 2019, for Accredited Certificate Issuance System Based on Block chain and Accredited Certificate Issuance Method Based on Block chain Using Same, and Accredited Certificate Authentication System Based on Block chain and Accredited Certificate Authentication Method Based on Block chain Using Same.

### BRIEF DESCRIPTION OF THE DRAWINGS

The novel features of the invention are set forth with particularity in the claims. A better understanding of the features and advantages of the present invention will be obtained by reference to the following detailed description that sets forth illustrative embodiments, in which the principles of the invention are utilized, and the accompanying drawings of which:

FIG. 1A is a block diagram illustrating a blockchain system environment suitable for use with the disclosed voucher system;

FIG. 1B is a block diagram illustrating a blockchain system environment suitable for use with the disclosed distribution system;

FIG. 1C is a block diagram illustrating a blockchain system environment suitable for use with the disclosed trust system;

FIGS. 2A-2G are flow diagrams illustrating a gift voucher creation process;

FIGS. 3A-3B are flow diagrams illustrating a gift voucher delivery process;

FIGS. 4A-4C are flow diagrams illustrating a gift voucher redemption process;

FIGS. 5A-5G are flow diagrams illustrating a coaching voucher creation process;

FIGS. 6A-6B are flow diagrams illustrating a coaching voucher delivery process;

FIGS. 7A-7C are flow diagrams illustrating a coaching voucher redemption process;

FIG. 8 is a flow diagram illustrating a coaching process between the user, the advisor and the recipient;

FIG. 9 is an overview of an exemplar trust distribution process;

FIG. 10A is a flow diagram illustrating a portion of the process for creating a user account;

FIG. 10B is a flow diagram illustrating a recipient agreement process;

FIG. 10C is a flow diagram illustrating of a trust recipient allocation process;

FIGS. 11A-B are a flow diagram illustrating a distribution process based on a triggering event;

FIG. 11C is a flow diagram illustrating a trust distribution process which can occur after receiving a death notice;

FIG. 12 is a flow diagram illustrating a disbursement process;

FIG. 13 is a deployment of funds process; and

FIGS. 14A-14D are trust distribution flow diagrams.

### DETAILED DESCRIPTION

### I. Blockchain Process

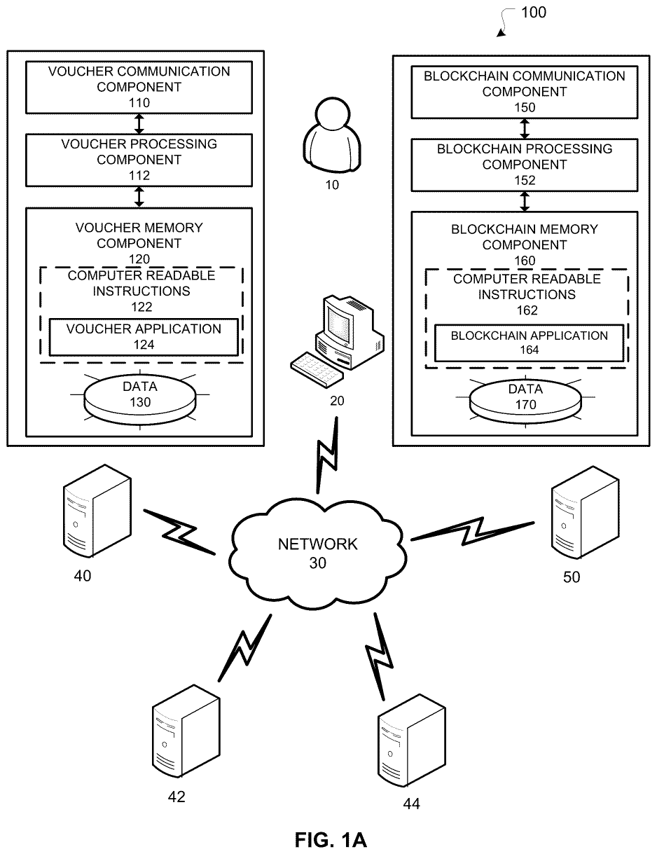

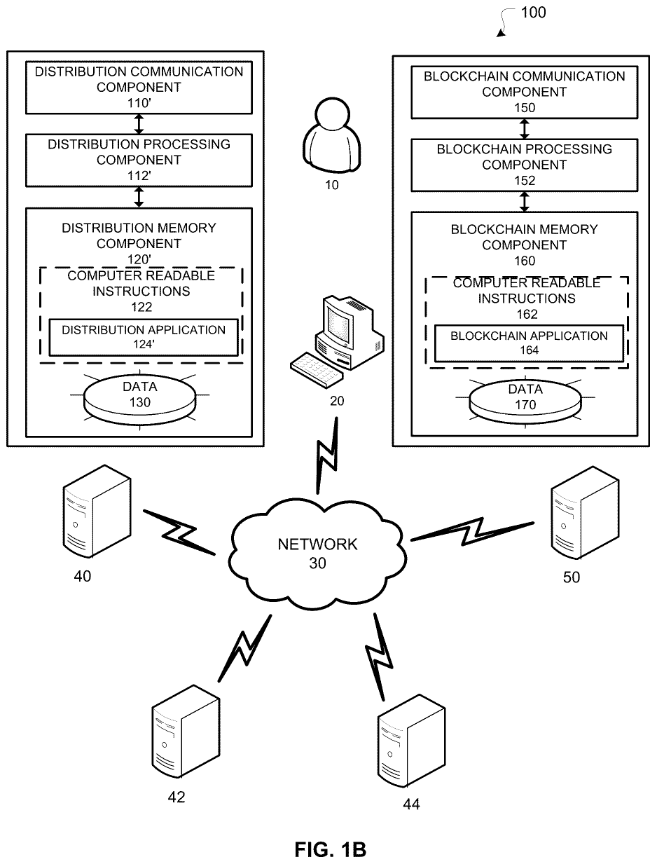

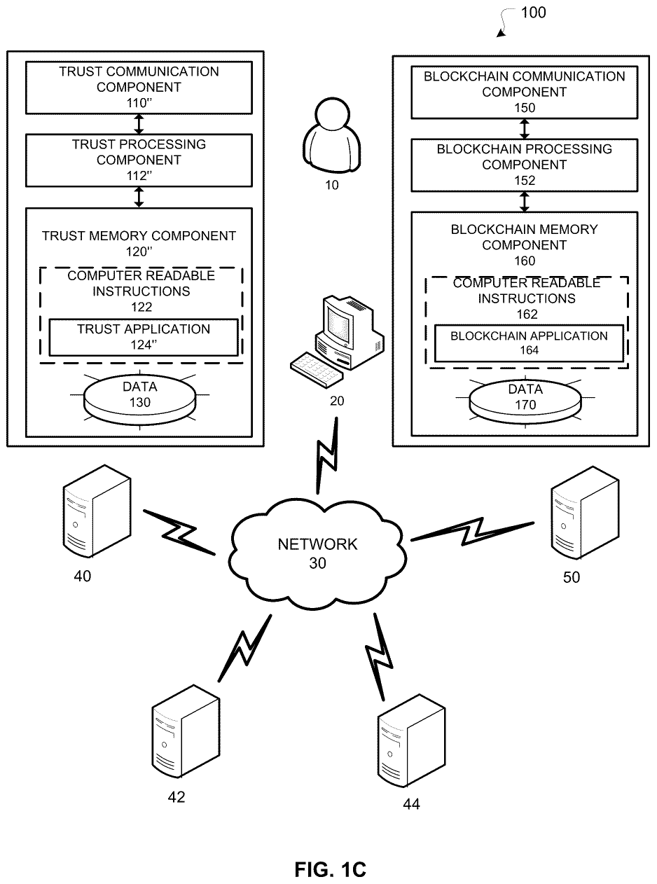

Turning now to FIGS. 1A-C, a blockchain and voucher system 100 generally comprises one or more blockchain communication components 150, one or more blockchain processing components 152, and one or more blockchain memory components 160. The one or more blockchain processing components 152 are operatively coupled to the one or more blockchain communication components 150 and the one or more blockchain memory components 160. As will be appreciated by those skilled in the art, processing components and processors generally includes circuitry used for implementing the communication and/or logic functions of a particular system. For example, a blockchain processing component 152 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more blockchain processing components 152 may include functionality to operate one or more software programs based on blockchain computer-readable instructions 162 thereof, which may be stored in the one or more blockchain memory components 160.

The one or more blockchain processing components 152 use the one or more blockchain communication components 150 to communicate with the network 30 and other components on the network 30, such as, but not limited to, the user computer systems 20, first entity systems 40, second entity systems 42, Nth entity systems 44, or other like systems. As such, the one or more blockchain communication components 150 generally comprise a wireless transceiver, modem, server, electrical connection, electrical circuit, or other component for electronically communicating with other components on the network 30. The one or more blockchain communication components 150 may further include an interface that accepts one or more network interface cards, ports for connection of network components, Universal Serial Bus (USB) connectors and the like.

A blockchain can be comprised of one or more blocks (digital information) and/or sub-blockchains which can also be comprised of one or more blocks, in a chain (database). Blocks store information about transactions. A single block on a blockchain can store as much as 1 MB of data (e.g., a few thousand transactions per block). Once a process is completed, the block can be configured so that it cannot be written to following completion. Data, e.g. event records, blocks and/or blockchains (such as sub-blockchains) can be appended to a blockchain. The blockchain is a distributed ledger system on a peer-to-peer network that operates without utilizing a centralized transaction authority. The blockchain distributed ledger provides transparency and immutability. Changes to the blockchain ledger are viewable by all permissioned participants and the corresponding transactions cannot be altered or deleted. Additionally, the system is configurable to generate a unique hash value for each of the block entries, such as documents reviewed and signed, based on a secure hash algorithm in real time and store each unique hash value on the voucher blockchain.

As further illustrated in FIGS. 1A-C, the blockchain system 50 comprises blockchain computer-readable instructions 162 stored in the blockchain memory component 160, which in one embodiment includes the blockchain computer-readable instructions 162 of the blockchain application 164. In some embodiments, the one or more blockchain memory components 160 include one or more blockchain data stores 170 for storing data related to the blockchain systems 50, including, but not limited to, data created, accessed, and/or used by the blockchain application 164.

The blockchain systems 50, and the components therein, may be one or more private blockchains, one or more public blockchains, and/or one or more hybrid blockchains. Moreover, the blockchain systems 50 may be located in or associated with the other systems described herein.

Users 10 may access the blockchain application 164 on the one or more blockchain systems 50, or a portion thereof stored on other systems (e.g., a portion of the blockchain application 164 stored on the user computer systems 20 or first entity systems 40, second entity system 42 or nth entity system 44), or through other applications, through a user computer system 20. The user computer system 20 may be a desktop, laptop, tablet, mobile device (e.g., smartphone device, or other mobile device), or any other type of computer that generally comprises one or more voucher communication components 110 (FIG. 1A), distribution communication components 110′ (FIG. 1B), or trust communication components 110″ (FIG. 1C), one or more voucher processing components 112 (FIG. 1A), distribution processing components 112′ (FIG. 1B), or trust processing components 112″ (FIG. 1C), and one or more corresponding voucher memory components 120 (FIG. 1A), distribution memory components 120′ (FIG. 1B) or trust memory components 120″ (FIG. 1C).

The one or more voucher processing components 112 (FIG. 1A), distribution processing components 112′ (FIG. 1B), or trust processing components 112″ (FIG. 1C) are operatively coupled to the one or more voucher communication components 110 (FIG. 1A), distribution communication components 110′ (FIG. 1B), or trust communication components 110″ (FIG. 1C), and the one or more corresponding voucher memory components 120 (FIG. 1A), distribution memory components 120′ (FIG. 1B) or trust memory components 120″ (FIG. 1C). The one or more voucher processing components 112 (FIG. 1A), distribution processing components 112′ (FIG. 1B), or trust processing components 112″ (FIG. 1C) use the one or more respective voucher communication components 110 (FIG. 1A), distribution communication components 110′ (FIG. 1B), or trust communication components 110″ (FIG. 1C)to communicate with the network 30 and other components on the network 30, such as, but not limited to, the blockchain systems 50, the first entity systems 40, the second entity systems 42, the Nth entity systems 44, or other systems. As such, the one or more voucher communication components 110 (FIG. 1A), distribution communication components 110′ (FIG. 1B), or trust communication components 110″ (FIG. 1C) generally comprise a wireless transceiver, modem, server, electrical connection, or other component for electronically communicating with other components on the network 30. The one or more blockchain communication components 150 may further include an interface that accepts one or more network interface cards, ports for connection of network components, Universal Serial Bus (USB) connectors and the like. Moreover, the one or more voucher communication components 110 (FIG. 1A), distribution communication components 110′ (FIG. 1B), or trust communication components 110″ (FIG. 1C) may include a keypad, keyboard, touch-screen, touchpad, microphone, mouse, joystick, other pointer component, button, soft key, and/or other input/output component(s) for communicating with the users 10.

As illustrated in FIGS. 1A-C, the user computer systems 20 may have a voucher computer-readable instructions 122 stored in the one or more corresponding voucher memory components 120 (FIG. 1A), distribution memory components 120′ (FIG. 1B) or trust memory components 120″ (FIG. 1C), which in one embodiment includes the voucher computer-readable instructions 122 of corresponding voucher applications 124 (FIG. 1A), distribution application 124′ (FIG. 1B), or trust application 124″ (FIG. 1C), such as dedicated applications (e.g., apps, applet, or the like), portions of dedicated applications, web browser or other apps that allow access to applications located on other systems, or the like. As previously discussed, the blockchain application 164, or a portion thereof, may be stored on each of the user computer systems 20.

As illustrated in FIGS. 1A-C, the first entity systems 40, the second entity systems 42, the Nth entity systems 44, or other systems are operatively coupled to the blockchain systems 50 and/or user computer systems 20, through the network 30. These systems have components that are the same as or similar to the components described with respect to the blockchain systems 50 and/or user computer systems 20 (e.g., one or more communication components, one or more processing components, and one or more memory devices with computer-readable instructions of one or more applications, one or more datastores, or the like). Thus, the first entity systems 40, the second entity systems 42, the Nth entity systems 44, or other systems communicate with the blockchain systems 50, the user computer systems 20, and/or each other in same or similar way as previously described with respect to the blockchain systems 50 and/or the user computer systems 20. The first entity systems 40, second entity systems 42, Nth entity systems 44 may be made up of one or more user computer systems 20, one or more of the blockchain systems 50, or other entity systems that act as nodes which are utilized to store, disseminate, and/or validate event information for events within the blockchain. It should be further understood that the blockchain systems 50 may be separate systems and/or a part of each user computer system 20, and/or first entity systems 40, second entity systems 42, Nth entity systems 44.

Rather than utilizing a centralized database to access, view, store, disseminate, and/or validate information, the present voucher system utilizes a decentralized blockchain configuration or architecture to order to allow users 10 to access, view, store, disseminate, and/or validate information, or take another action related to an event. Such a decentralized blockchain configuration ensures accurate mapping and validation of event information, and provides a secured network over which information may be validated. Accordingly, blockchain configurations may be utilized with respect to any type of information, such as, but not limited to maintaining an accurate ledger of information, such as resource transfer information (e.g., transaction, asset transfer, sale, or other like transfer of value information), personal information, credit history information, or the like, in order to provide validation, such as validation of resource transfers, or access to personal information, or the like.

As will be appreciated by those skilled in the art, a blockchain, or “blockchain,” is a distributed database that maintains a list of data records, the security of which is enhanced by the distributed nature of the blockchain. A blockchain typically includes several nodes, which may be one or more entities, systems within an entity, machines, computers, databases, data stores, or the like operably connected with one another. For example, the various systems described with respect to FIGS. 1A-C, or systems within the systems described with respect to FIGS. 1A-C may be nodes. In some aspects of the disclosure, an entity may be a node of a blockchain, and internal users or external users 10 may access the entity systems in order to take actions with respect to an event. In other aspects of the various systems, any nodes may or may not be grouped together and associated with the entity. Each of the nodes or multiple nodes can be maintained by different entities, or components within an entity, and as such different systems within an entity or between entities may act as nodes.

A blockchain typically works without a central repository or single administrator. However, a network of nodes within a single entity or group of entities may together serve as a central repository or single administrator that can control access to the blockchain that is associated with a plurality of different nodes. One application of a blockchain is the public ledger of resource transfers for cryptocurrencies, such as used in bitcoin. In this use of a blockchain, the data records recorded in the blockchain are enforced cryptographically and stored on the nodes of the blockchain within a voucher system. The distributed blockchain network disclosed herein can have at least one private blockchain portion and in some cases a public blockchain portion. The system allows users to take actions (e. g, accessing, viewing, storing, disseminating, validating, or the like) with respect to the vouchers. Each block is a time-stamped series of an immutable record of data that is managed by cluster of computers not owned by any single entity. Each of these blocks of data (i.e. block) are secured and bound to each other using cryptographic principles (i.e. chain). Portions of the distributed ledger can form a smart contract which includes an offer, acceptance and consideration.

A blockchain provides numerous advantages over traditional databases. For example, with respect to utilizing a blockchain for resource transfer information, a large number of nodes of a blockchain may reach a consensus regarding the validity of a resource transfer contained on a decentralized resource transfer ledger. Similarly, when multiple versions of a document or resource transfer exits on the ledger, multiple nodes can converge on the most up-to-date version of the resource transfer. For example, in the case of a virtual currency resource transfer, any node within the blockchain that stores or validates the resource transfer, can determine within a level of certainty whether the resource transfer can take place and become final by confirming that no conflicting resource transfers (i.e., the same currency unit has not already been spent) are confirmed by the blockchain elsewhere on other nodes.

The blockchain typically has two primary types of records. The first type is the event type (e.g., resource transfer type, document type, or the like), which consists of the actual data stored in the blockchain. The second type is the block type, which are records that confirm when and in what sequence certain events (e.g., resource transfers, or the like) became recorded as part of the blockchain. Events (e.g., resource transfers, or the like) are created by participants using the blockchain in its normal course of business, (for example, when someone sends cryptocurrency to another person), blocks are created by users known as “miners” who use specialized software/equipment to create the blocks for the event. Users of the blockchain create blocks for the events (e.g., resource transfers, or the like), which are passed around to various nodes of the blockchain. A “valid” resource transfer is one that can be validated based on a set of rules that are defined by the particular system implementing the blockchain.

Blockchains are typically decentralized. A distributed ledger (e.g., a decentralized ledger) is maintained on multiple nodes of the blockchain. One node in the blockchain may have a complete or partial copy of the entire ledger or set of events (e.g., resource transfers, or the like) and/or blocks on the blockchain. Events (e.g., resource transfers, or the like) are initiated at a node of a blockchain and communicated to the various other nodes of the blockchain. Any of the nodes, or users of the nodes, which have access to the blockchain to validate an event, add the event to its copy of the blockchain, and/or broadcast the event (e.g., resource transfer or the like) its validation (in the form of a block) and/or other data to other nodes. This other data may include time-stamping.

Various other applications of blockchains may be utilized for the voucher application. These include contract execution, analyst reporting, financial reporting, synchronous/asynchronous communication, controlling access to or dissemination of timeline, personal, and/or financial data and even a general purpose deployment of decentralized applications. As such, blockchains may be utilized to access, view, store, create, disseminate, and/or validate any type of event information, or take any other type of action with respect to event information associated with an event.

In various aspects, the blockchain may be configured with a set of rules (otherwise described herein as “limits”) to dictate what actions may be taken by users and/or nodes for various events, how information may be accessed, created, stored, disseminated, and/or validated, and/or how the network communicates information throughout the one or more blockchains across the nodes of various entities associated with the nodes (e.g., supports the nodes on the entity systems). In some aspects, the rules dictate that an originating node (i.e., a node through which a resource transfer was initiated) must approve all actions for events mapped to that node. In some aspects, the rules dictate that some or all actions for events may be approved by one or more validator nodes without further input from the originating node. In some such cases, the rules dictate that additional information is needed in determining whether an action for an event should be approved. In other aspects, the validating node must reach out to the originating node in certain situations as dictated by the rules. For example, if the action for the event, such as validating a resource transfer, is in any way, indicated to be a faulty or invalid (due to some information present on the blockchain), then the rules may dictate that the validating node communicate with the originating node to confirm or deny validation of the event.

In some aspects, the validator may approve the event (e.g., resource transfer, or the like) without communicating with the originating node. In such a case, the validator (or a group or all of validators if multiple or universal validations, respectively, are required by the rules), can approve the action for the event based solely on the information contained in the blockchain. Thus, if an action for an event is requested and a validator receives the action for the event, it can check the actions for the event against its ledger to determine whether an originating node has validated the event. If so, then the validator may approve the action for the event. In this regard, the action for the event may be approved very quickly, and in some cases, in real-time or near real-time.

In various aspects, any of the blockchain nodes may be a validator or a miner that validates events (e.g., resource transfers, or the like). In some aspects, a number of the nodes must validate an event (e.g., resource transfer, or the like) in order for the event to be approved. For example, in one embodiment, two or three nodes must validate the authenticity of the event, or portions thereof, before the event may be approved. As noted above, in some instances, the rules of the blockchain and/or rules specific to particular originating entities or validators dictate that validators cannot approve events without confirming available information (e.g., funds used in a resource transfer). In some cases, the available information is already associated with an alias on the public blockchain, or associated with a customer within an entity controlling a private blockchain, but in other cases, the validator on the blockchain must communicate with the originating entity in order to request approval of the event (e.g., resource transfer, or the like).

In some aspects, the rules may only be changed by the originating node (maintained by an originating entity or entities that control the blockchain) to ensure the validity of a change to a rule. In some cases, particularly in cases where one or more nodes have raised a concern that an event is not valid, the originating node may be contacted for verification of the event.

In various aspects, the event, or information for the event, is stored and executed from one or more systems and is not placed on the public blockchain itself, and instead is located on a private portion of the blockchain. In some aspects, the event, or information for the event, is only stored and executed from a subset of the nodes of the blockchain, which, in some aspects, are synonymous with validator nodes and in other aspects are not synonymous with the validator nodes. In some aspects, placeholder(s) for the event (e.g., resource transfers, or the like) indicating that the event exists and/or a description of the event, is accessible from private blockchains and may be placed on the public blockchain. The placeholder(s) may be identifiers (e.g., characters, or the like) and/or a description of the event. In some cases, the event may be executed only by the designated one or more systems (e.g., on the private blockchain, or on a private portion of a blockchain). Such systems may utilize a key or other security mechanism(s) in order to ensure only certain nodes are allowed access to the information related to the private blockchain portion. In some cases, this configuration may result in additional security instead of placing the event on the public blockchain for any node to execute.

### II. Voucher System Overview

Turning to the disclosed voucher systems, in an initial process a user creates an account within the system. During the account creation process, the user specifies a plan, identifies one or more plan controllers, specifies one or more accounts to be accessed, identifies one or more advisors, identifies one or more recipients. During this process, the system creates a block for the blockchain for this transaction.

The voucher system is a service provider that has a variety of system participants including but not limited to: the account holder (user), the recipient, the beneficiary, the plan controller, the advisor, the spouse, the verification contact, etc.

During the set-up process, the user also indicates a marital status. If the user is married, then information about the spouse is entered into the voucher system and a spousal consent agreement is sent electronically to the spouse. In one configuration, the spouse prints the authorization, signs the authorization in front of a witness or Notary Public, and then returns an electronic copy of the completed document. Return of the electronic copy can occur by any suitable process including, for example, uploading a photo of the signed document via a mobile device. The system can then review the document for legibility to ensure the document appended is the authorization and the information required is present and legible. If the information is not legible, the system can flag the document for human review and/or notify the person uploading the document that the quality of the document is not sufficient. In another configuration, the spouse creates an account with the system and accesses an electronic version of the consent agreement. The spouse is then given the opportunity to accept or reject the agreement. In order to complete the acceptance biometric data, such as a fingerprint, may be required. Thus, for example, in a mobile environment, the spouse would choose accept and then be required to swipe a known finger across the fingerprint sensor embedded in the phone.

Once the user identifies an advisor and indicates a marital status, a notification is sent to the advisor notifying the advisor that the advisor has been identified as the advisor for the user in the voucher system and requesting the advisor confirm or indicate a marital status for the user. In response to the marital status inquiry, the advisor confirms the marital status. In one configuration, for example, the advisor can be presented with an option such as “John Smith-married” with a confirm YES/NO option. In another configuration, the advisor can be required to independently indicate a marital status for the user. Once the advisor indicates the marital status of the user, the voucher system determines if the marital status is correct by either determining that the advisor has indicated a positive confirmation or has entered the same marital status as the user. If the marital status is correct (YES), then the process proceeds to completion. If the marital status is not correct (NO), then the voucher system notifies the user and requests the information be updated.

If the user is unmarried and the advisor confirms that the user in unmarried, then the plan and distribution details are finalized and the plan controller executes the contract. The plan controller can have limited or restricted permissions. Permissions for the plan controller can be set to change upon the occurrence of one or more defined events (e.g., incapacity or death of the user). Once all the components are completed, the plan is finalized and distribution details are completed.

### III. Gift Voucher System Overview

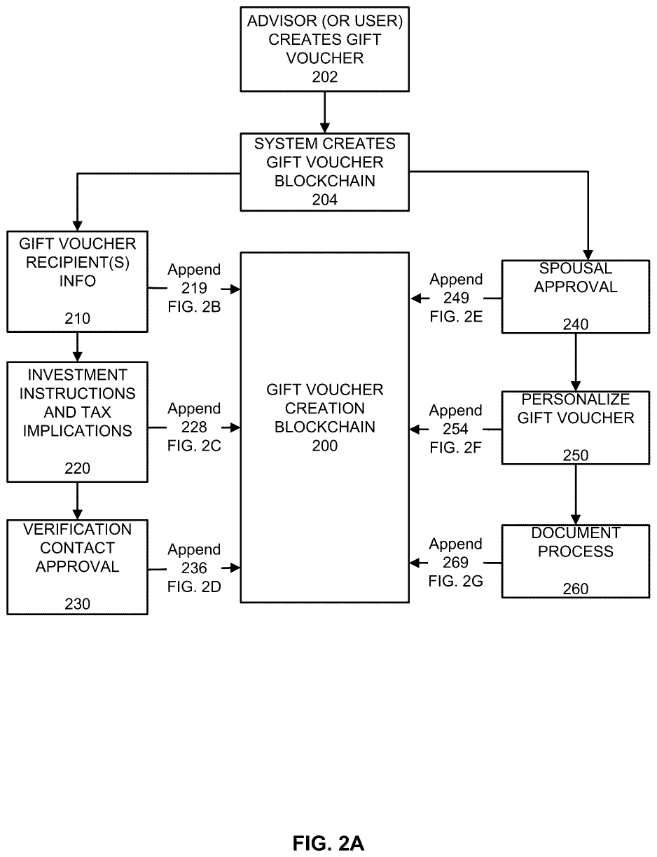

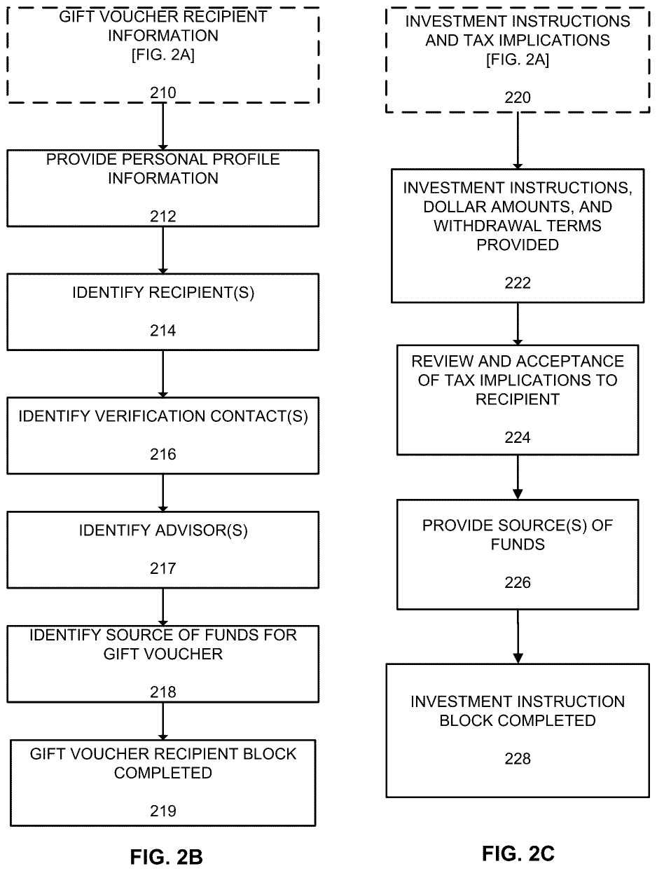

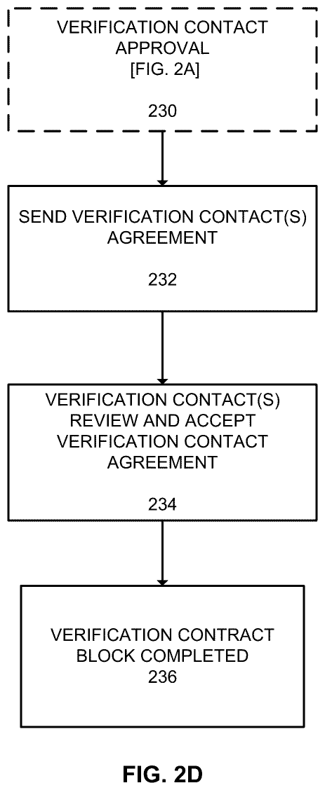

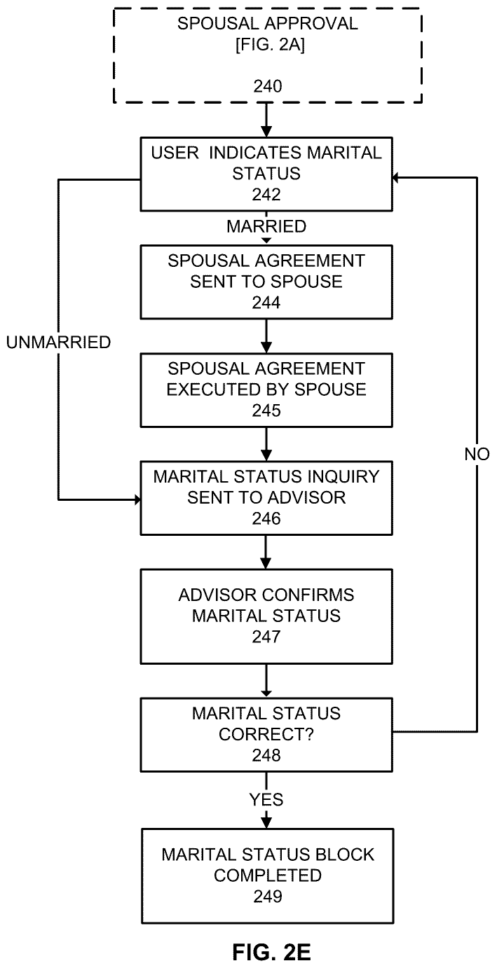

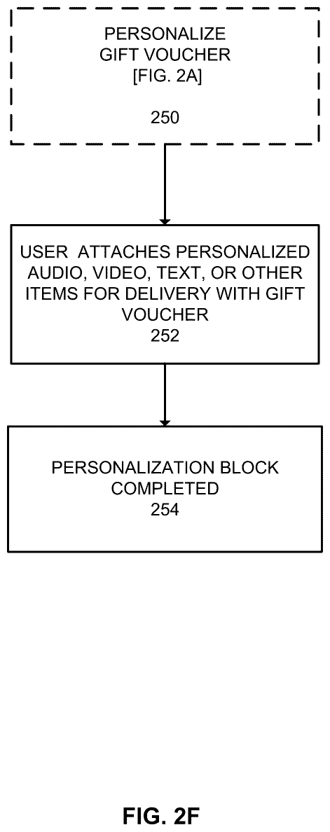

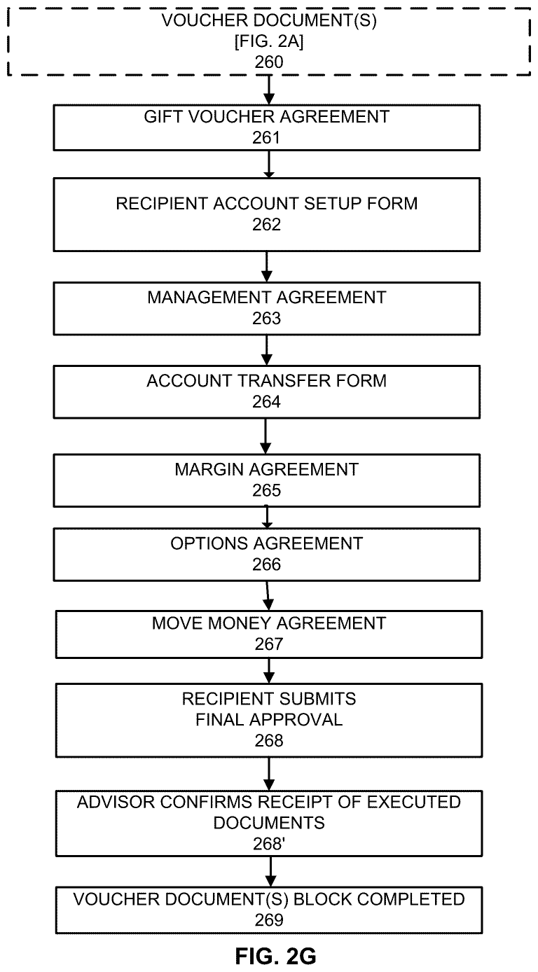

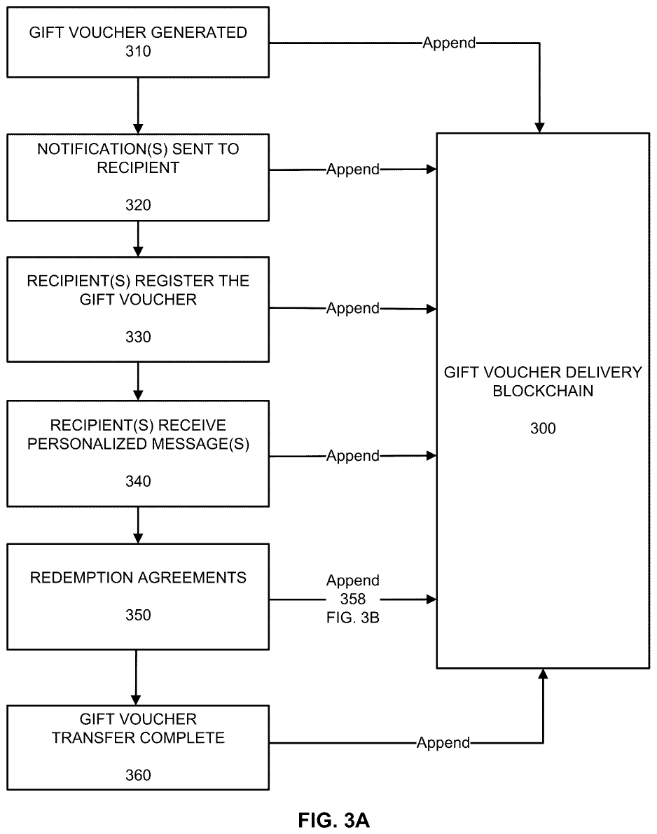

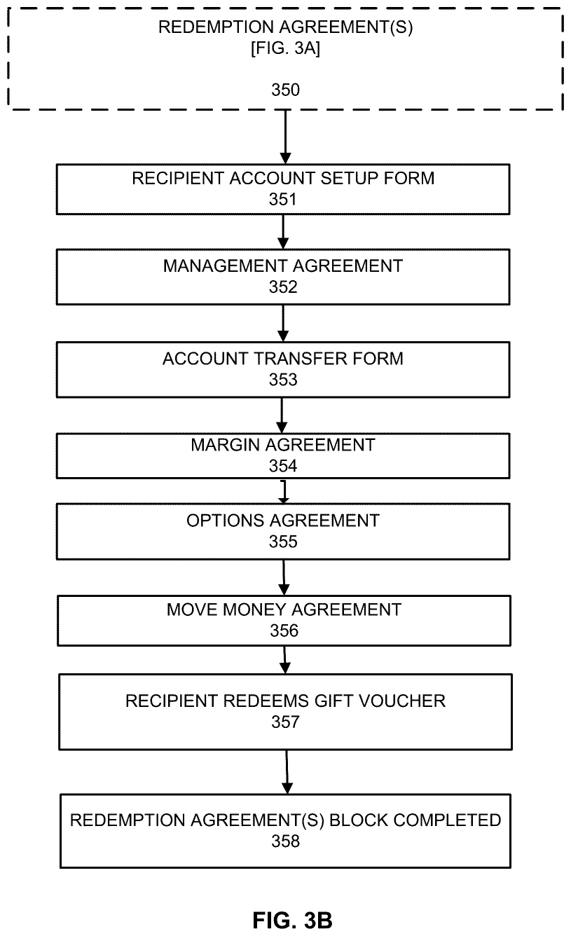

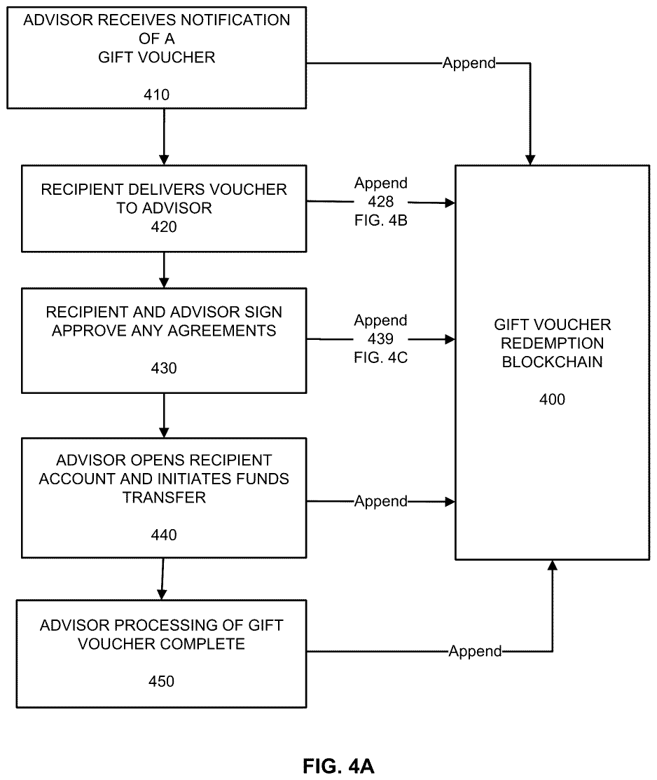

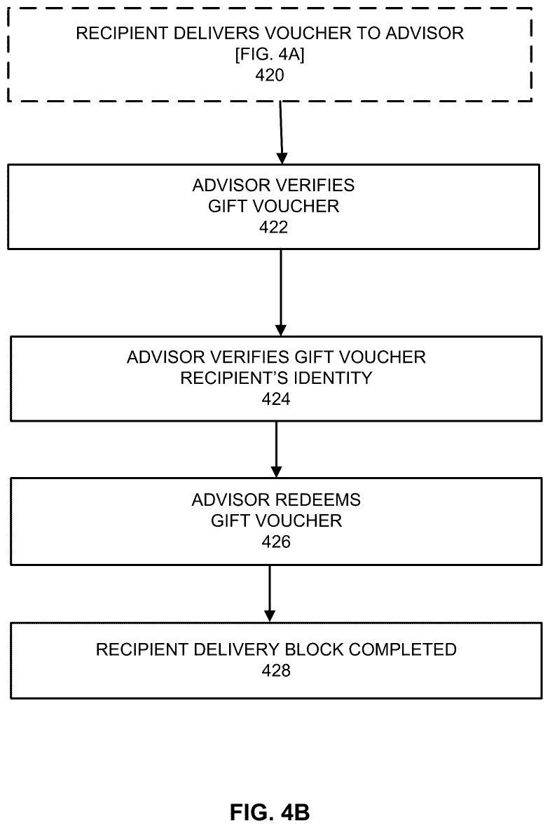

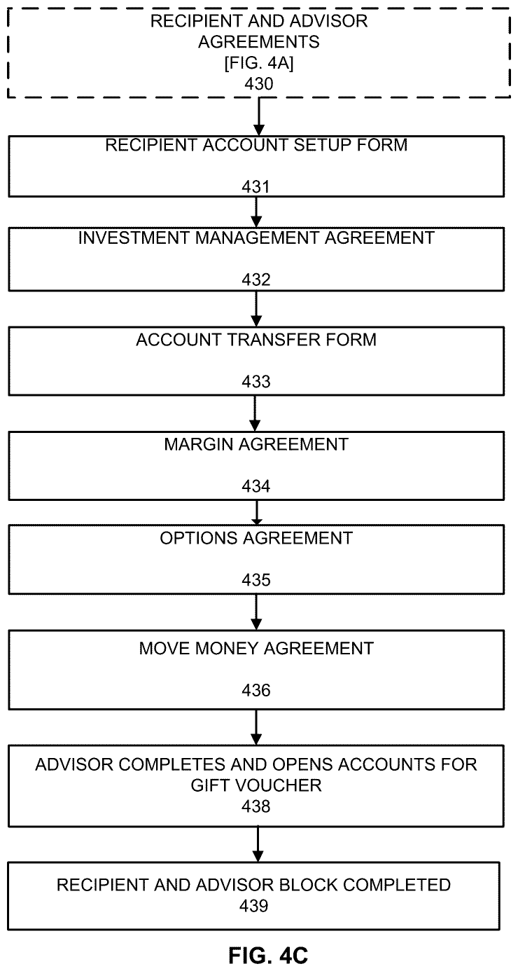

The processes illustrated in FIGS. 2-4 can be part of a computer program product for administering a gift voucher within a blockchain distributed network. The gift voucher process includes, for example, one or more smart contracts between participants of the voucher system, and/or the voucher system controller and voucher system participants, and consists of three separate components, a gift voucher creation process (shown in FIGS. 2A-2G) , a gift voucher delivery process (FIGS. 3A-3B) and a gift voucher redemption process (FIGS. 4A-4C). Each of the gift voucher processes are unique with different participants and event records appended to the gift voucher creation blockchain ledger created for the system user and the service provider by the service provider computer program. All three gift voucher components are required to execute fully and in order to consider the gift voucher complete and fully executed. The gift voucher delivery component requires the gift voucher creation to execute fully before it may commence and the gift voucher redemption process and the gift voucher delivery component must be fully executed before it commences delivery. Once the gift voucher is processed, the recipient takes full control of the resulting accounts and the user is no longer involved. Each time data is appended to the blockchain (e.g., a block is created and appended to the blockchain), the blockchain is updated.

Turning now to FIGS. 2A-2G, the gift voucher creation process between the user, the advisor and optionally a trusted contact is illustrated. FIG. 2A is an overview of a gift voucher creation blockchain 200 process. The advisor (or user), using a computer program, creates the gift voucher agreement 202. The gift voucher agreement is then part of a smart contract blockchain with event record requirements of the system user, the recipient, the advisor and the verification contact. The advisor can facilitate the initial creation of the smart contract under the direction of the system user. In another configuration, the system user can begin the voucher creation process directly. The system then creates the gift voucher blockchain 204. One or more additional process steps can be performed as part of the gift voucher blockchain 204, including, for example, providing gift voucher recipient information 210, providing investment instructions and advising of tax implications 220, obtaining verification contact approval 230 for being included as a participant in the gift voucher, obtaining spousal approval 240, personalizing the gift voucher 250, and document process 260. Information from each of the additional processes is appended to the gift voucher creation blockchain 200 as discussed below.

FIG. 2B illustrates a process for obtaining gift voucher recipient information 210. Personal profile information 212 is provided. One or more recipients 214 can also be provided along with one or more verification contacts 216, and one or more advisors 217. For each voucher recipient, a source of funds for the voucher 218 is identified. The system completes a gift voucher block input 219 from the entered data and appends the completed block to the gift voucher creation blockchain 200 in FIG. 2A.

FIG. 2C illustrate a process for providing investment instructions and tax implications 220 which is completed by a user and the advisor and appended to the block. Investment instructions, dollar amounts and withdrawal terms can be specified by the user 222. A summary of tax implications is sent to the recipient 224. Additionally, a summary of the tax implications can be provided to the user. A source of funds can be provided 226. The system completes the investment instruction block input 228 and appends the completed block to the gift voucher creation blockchain 200 in FIG. 2A.

FIG. 2D illustrates verification contact approval option 230. The user provides a verification contact for one or more vouchers. A verification contact agreement is sent to the verification contact 232. The verification contact receives and approves the verification contact agreement 234. Once the verification contact agreement 234 is approved, the verification contact block input 236 is completed and appended to the gift voucher creation blockchain 200 in FIG. 2A. As will be appreciated by those skilled in the art, a user can specify different verification contacts for different recipients, or groups of recipients. Additionally, if the user did not specify a verification contact, no input is created or appended. The verification contact agreement allows the system to contact the verification contact. The verification contact typically does not have authority to make changes to the voucher process established by the user. For example, if a user designates their sister as a trusted administrator, which is a verified contact, when the user passes away, she will receive the list of what the user had going out of the trust. If she is “limited” then she just sees on a “newsfeed” within the app. If she has “full access” then she can push the money or gift icon and see what was or is being sent in detail like dollar amounts. The verification contact sees the “alerts” occurring in the system as part of the or voucher set-up. If the recipient has not obtained the item, then the verification contact can obtain contact information for the recipient and, for example, call the recipient to alert the recipient that they need to log into the system to update contact information or obtain any item that is waiting (including messages, videos and the like. The voucher can be set-up so that any remainder at the end of the life of the trust is transferred to the verification contact at the discretion of the user.

FIG. 2E illustrates a user spousal approval requirement process 240 completed by user and advisor and appended to the blockchain. The user indicates marital status 242, if the user is married, then a spousal agreement is sent to the user's spouse 244, the spousal agreement is then executed by the spouse 245. If the user is unmarried, or the spousal agreement has been executed, a marital status inquiry is sent to the advisor 246. The advisor then confirms the marital status 247 as either married or unmarried. If the marital status is correct 248, then a marital status blockchain input 249 is completed and appended to the gift voucher creation blockchain 200 in FIG. 2A.

As will be appreciated by persons of skill in the art, if it is desirable, the recipients can also be subjected to a spousal agreement process similar to the user spousal approval process disclosed. In addition, or instead of sending the marital inquiry to the advisor, the marital inquiry can be sent to a trusted third person such as the verification contact.

FIG. 2F illustrates user gift voucher personalization optional requirements completed by user and appended to the gift voucher creation blockchain 200. If the user does not create and attach one or more personalized messages and other media the personalization blockchain 254 input is not created or appended. The personalize gift voucher 250 process includes the user attaching one or more of a personalized audio, video, text, or other item for delivery to the recipient 252 when the gift voucher is delivered to the recipient. Once the user creates the one or more personalized message, the personalization blockchain input 254 is completed and appended to the gift voucher creation blockchain 200 in FIG. 2A.

FIG. 2G shows a document process 260 required for the recipient to successfully redeem the gift voucher. Documents include one or more of a gift voucher agreement 261, a recipient account set-up form 262, a management agreement 263, an account transfer form 264, a margin agreement 265, an options agreement 266, and an authorization to move money agreement 267. Each agreement is reviewed and approved electronically by the appropriate party (e.g., user, recipient, etc.). Once the agreements are reviewed and signed, the agreements are submitted for final approval 268. Each event record or block can also contain a scanned facsimile in file format (i.e. pdf or jpg) of a document having a pen on paper signature which is appended in its entirety to the blockchain. The advisor can also confirm receipt 268′. A voucher document blockchain 269 input is then completed and appended to the gift voucher creation blockchain 200 in FIG. 2A.

FIGS. 3A-3B illustrates a gift voucher delivery blockchain 300 process. FIG. 3A shows each delivery action the system executes for the benefit of the recipient. A gift voucher is generated 310. Once the gift voucher is generated, a communication is transmitted to the recipient 320, e.g., via email and/or text. Upon receiving the communication, the gift voucher recipient creates an account and/or registers with the voucher provider service 330. After registering, the gift voucher recipient may receive personalized message 340, as allowed by privacy and personal preferences settings. The gift voucher recipient receives instructions on how to redeem the gift voucher 350. Once the gift voucher recipient redeems the gift voucher 357 (FIG. 3B), the gift voucher transfer is complete 360.

As shown in FIG. 3B, after the gift voucher recipient receives the redemption instructions 350, the participants to the gift voucher receives one or more of the following documents for review and conformation or acceptance: an account set-up form 351, a management agreement 352, an account transfer form 353, a margin agreement 354, an options agreement 355, and a move money agreement 356. Each agreement is reviewed and approved electronically by the appropriate party (e.g., user, recipient, etc.). Once the agreements are reviewed and approved, the gift voucher transfer is complete 370. Each step of reviewing and approving any agreements provided is recorded as a block which is appended to the gift voucher blockchain.

In some configurations, upon receiving a communication, e.g., an email and/or text notification(s), the recipient can download a mobile app through which registration can be completed.

FIGS. 4A-4C illustrate a gift voucher redemption blockchain 400 for a gift redemption process for one or more of the participants, e.g., advisor, recipient and verification contact. As shown in FIG. 4A the advisor can receive notification of a gift voucher 410. Once the gift voucher recipient delivers the gift voucher to the advisor 420, the gift voucher participants exchange, review and enter into agreements 430. Entering into the agreements can be electronically, via smart contracts, or by submitting documents with signatures. Once the agreements are in place the advisor opens one or more accounts for the gift voucher recipient and initiates a transfer of funds from a source 440. Once the funds are transferred, the gift voucher redemption process is complete 450.

Turning to FIG. 4B, the steps for the recipient delivering the voucher to the advisor 420, can also include the steps of the advisor verifying the gift voucher 422, the advisor verifying the recipient's identity 424, and the advisor redeeming the gift voucher 426. Once the recipient delivery block 428 is completed, the block is appended to the gift voucher redemption blockchain 400 in FIG. 4A.

FIG. 4C illustrates additional steps for the review and entering into agreement 430. The gift voucher participants receive one or more of the following documents for review and confirmation or acceptance: an account set-up form 431, an investment management agreement 432, an account transfer form 433, a margin agreement 434, an options agreement 435, and a move money agreement 436. Once the gift voucher recipient has reviewed and approved any required form or agreement, the advisor redeems the gift voucher for benefit of the gift voucher recipient's newly opened account 438 and the transfer is complete. A recipient and advisor block is created 439 and appended to the gift voucher redemption blockchain 400.

The system is also configurable to provide a news feed to each participant. The newsfeed advises of upcoming actions and provides for a regular request for update (e.g., annual update request). Alerts and notifications can be provided via the system newsfeed, via text message, via push notification, via email, or any other suitable available mechanism.

### IV. Gift Voucher Examples

### Example 1

In a first example, the user enters into an agreement (i.e. contracts) with the voucher system provider to administer a voucher. The funds for the voucher are distributed from the accounts identified by the user during the user set-up process to the voucher system. The voucher is transmitted to the advisor identified by the user for the benefit of the voucher recipient.

The voucher recipient can be a third-party beneficiary to the agreement between the user and the voucher system provider. In order to receive the benefit of the agreement between the user and the voucher system provider, the voucher recipient can be required to open an investment account for the funds with the advisor identified and maintain the account for the period of time specified in the agreement between the user and the voucher system provider. The user can include a provision that requires the funds to revert back to the user if the recipient does not honor the terms of the voucher.

### Example 2

An example of the investment gift voucher is the system user has a deposit account with funds (assets). The user enters into an agreement with the voucher system provider to administer a gift voucher. The funds for the gift voucher will be distributed directly to a new investment account with assistance from advisor and a verification contact for the benefit of the recipient.

The recipient can be a third-party to the agreement between the user and voucher system provider. In order to receive the benefit of the agreement between the user and the voucher system provider, the recipient can be required to open an investment account for the funds with the advisor identified and maintain the account for the period of time specified in the agreement between the user and the voucher system provider. The advisor is a third-party to the agreement between the user and voucher system provider. In order to facilitate the benefit of the agreement to the recipient, the advisor is required to set up an investment account for the recipient, transfer user funds to the new investment account and follow specific user investment instructions while advising the recipient investing of those funds.

The trusted contact is a third-party to the agreement between the user and voucher system provider. In order to facilitate the benefit of the agreement to the recipient, the trusted contact acts as an emergency contact should the other third parties encounter issues communicating with each other while executing the agreement between the system user and voucher system provider.

### Example 3

An example of the coaching voucher is the system user has an investment account with funds, securities and or other assets. The user enters into an agreement with voucher system provider to administer a coaching voucher. Trading authorization on the investment account will be granted with assistance from an advisor and trusted contact for the benefit of the recipient. The recipient is a third-party to the agreement between the user and voucher system provider. In order to receive the benefit of the agreement between the user and voucher system provider, the recipient is required to execute a trade authorization agreement with the advisor identified for the period of time specified in the agreement between the user and the voucher system provider.

The advisor is a third-party to the agreement between the user and voucher system provider. In order to facilitate the benefit of the agreement to the recipient, the advisor is required to submit the trade authorization agreement and follow specific user investment instructions while advising the recipient trading on the user's investment account.

The trusted contact is a third-party to the agreement between the user and voucher system provider. In order to facilitate the benefit of the agreement to the recipient, the trusted contact acts as an emergency contact should the other third parties encounter issues communicating with each other while executing the agreement between the system user and voucher system provider.

### V. Coaching Voucher System Overview

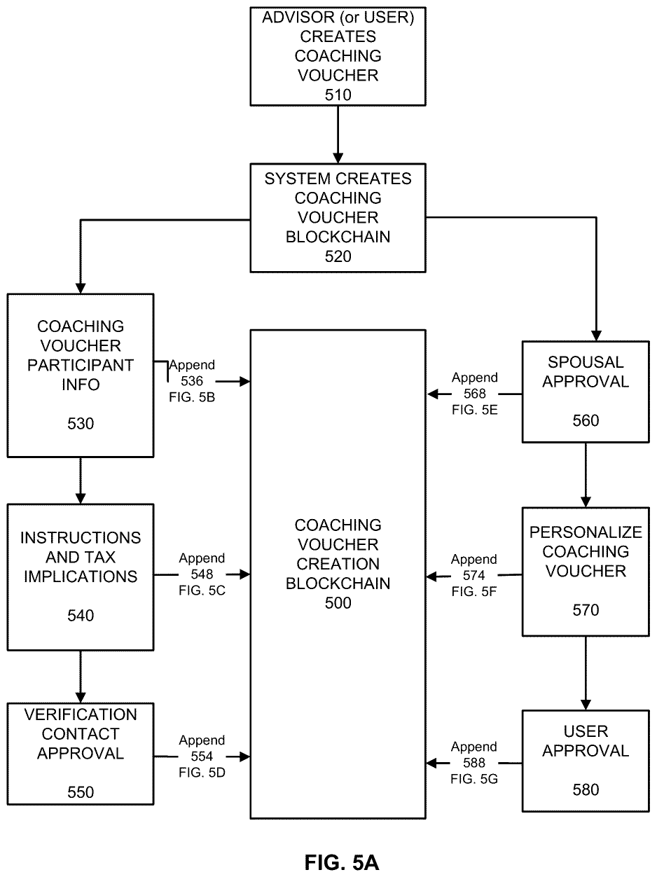

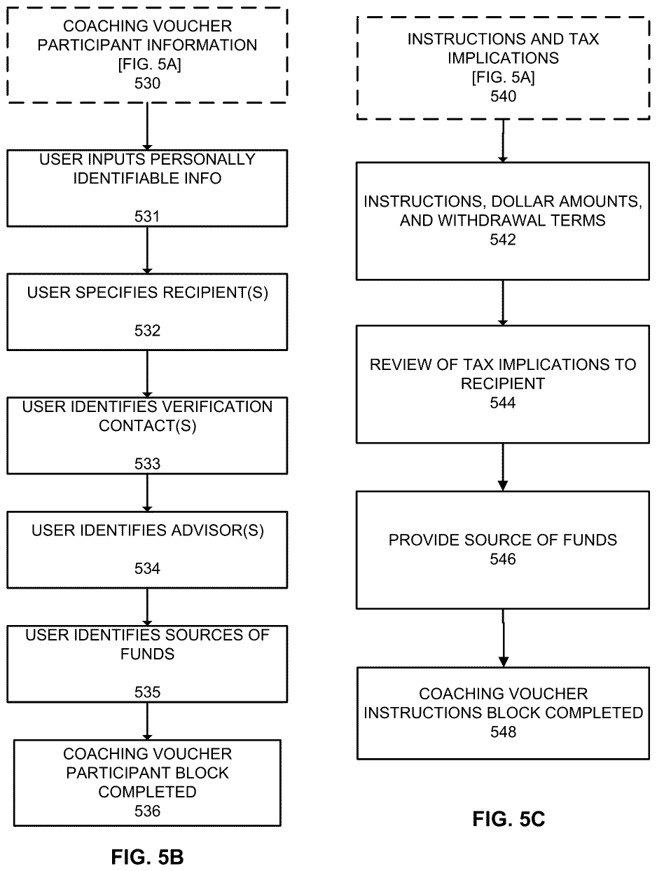

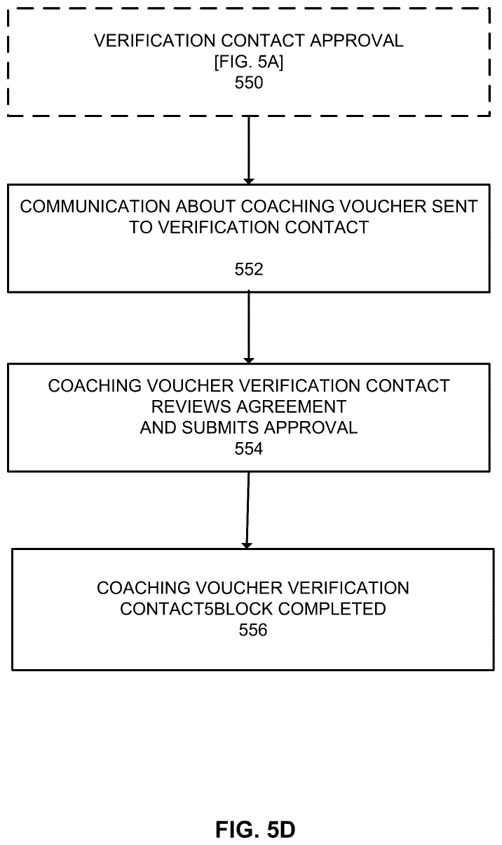

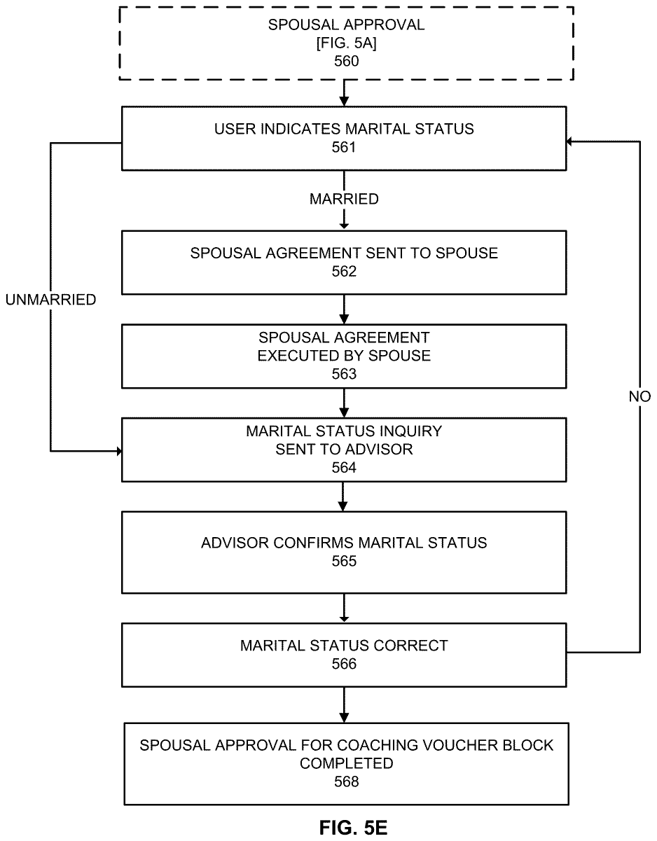

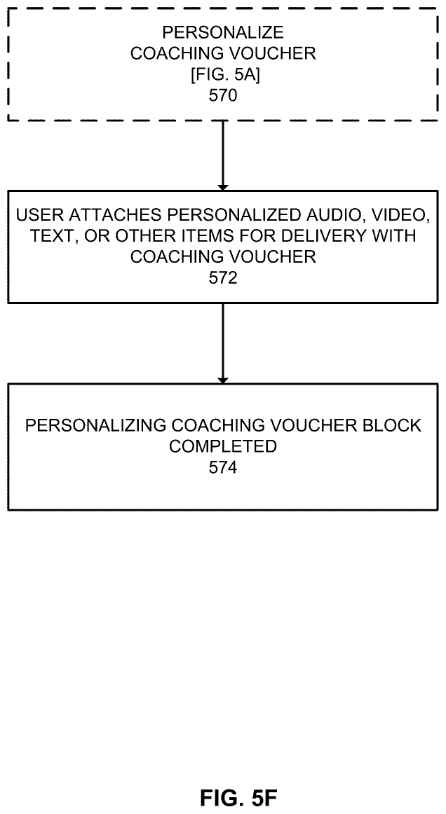

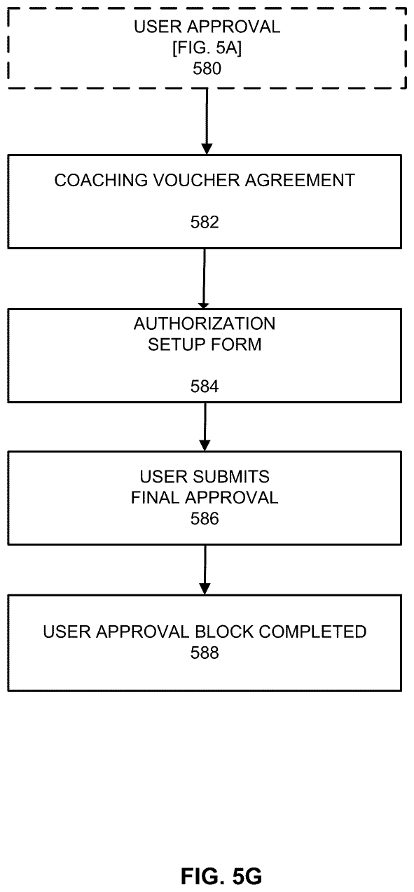

The processes illustrated in FIGS. 5-8 can be part of a computer program product for administering a coaching voucher within a blockchain distributed network. The coaching voucher system has many components that are similar to, or identical to, the gift voucher system. However, with the coaching voucher, the user continues to own the account at least during the coaching process. The voucher recipient only has the ability to provide instructions for the account for at least an initial period of time. The instructions from the recipient can be overridden by the user since the user maintains ownership of the account. After the passage of time, or upon a qualifying event (such as death), the account can then transfer from the user to full ownership by the recipient.

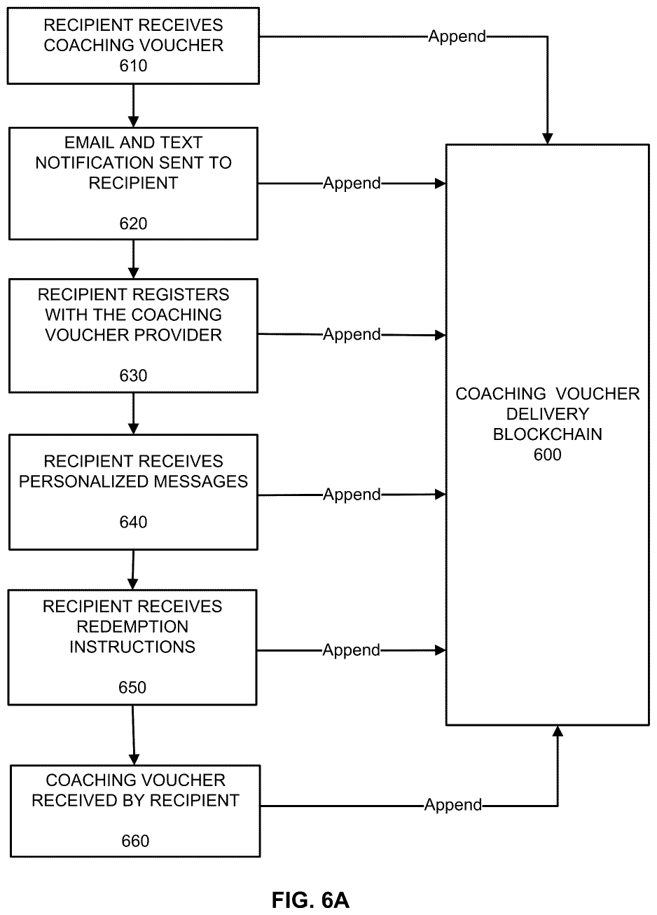

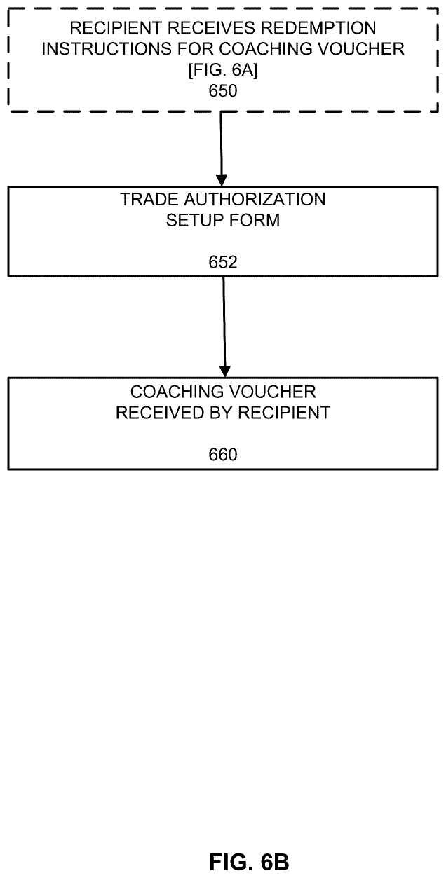

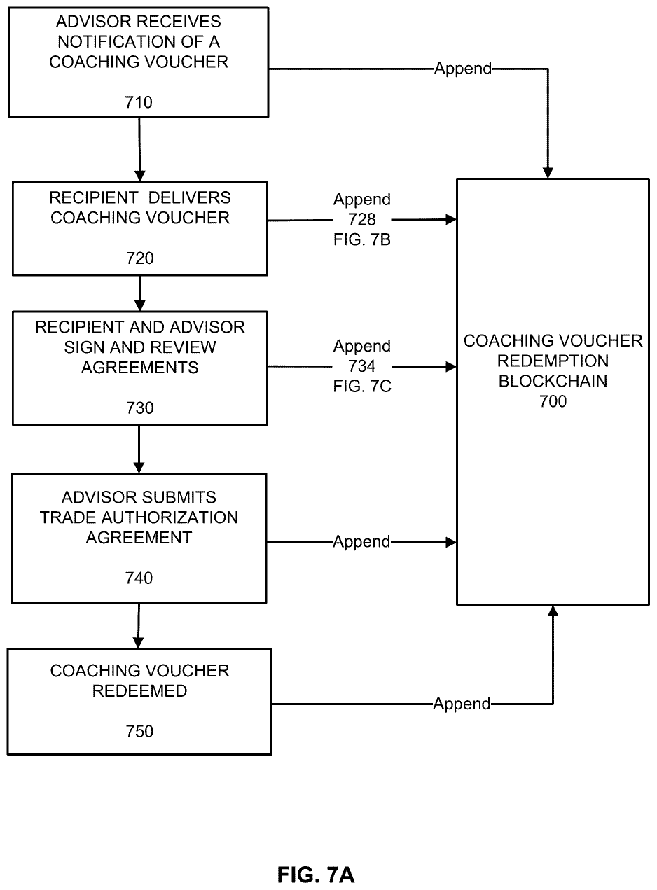

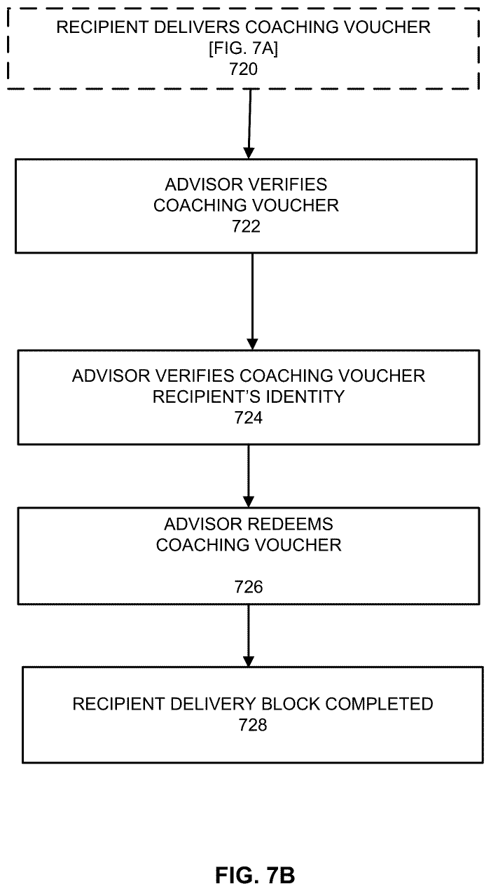

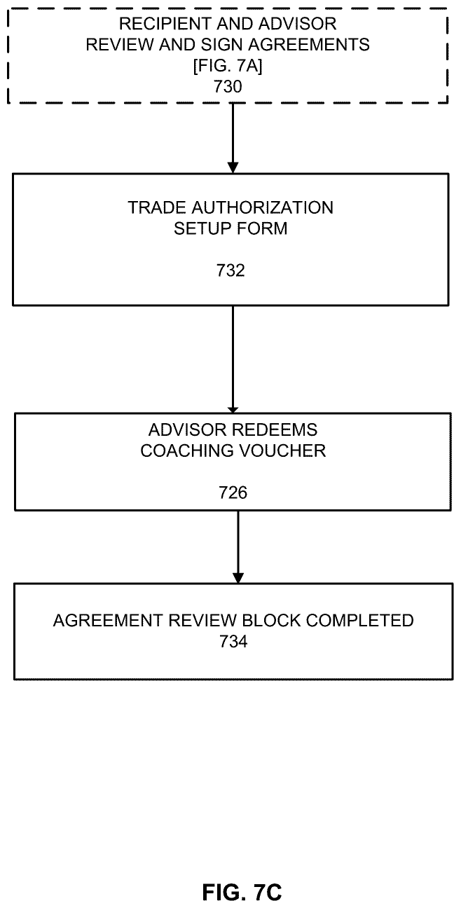

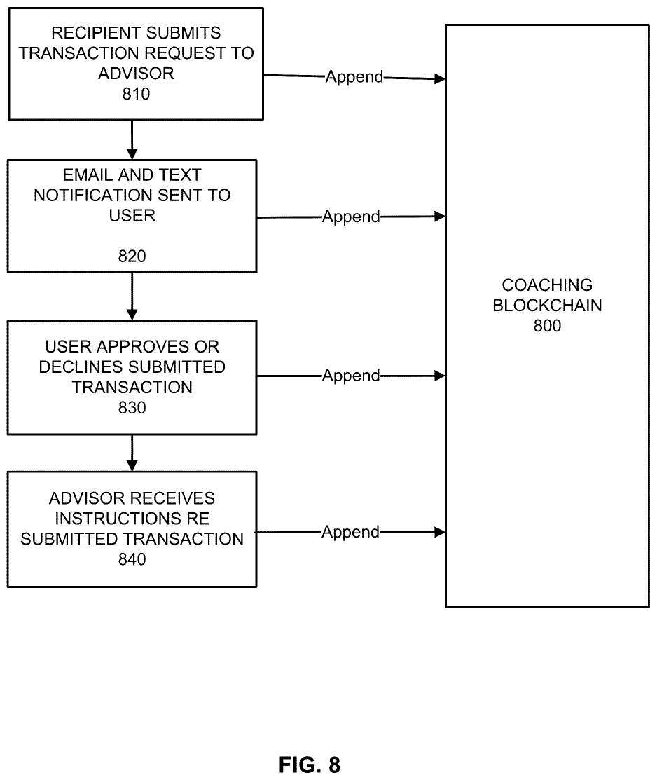

The coaching voucher consists of three separate components: a coaching voucher creation module (shown in FIGS. 5A-5G), a coaching voucher delivery module (FIGS. 6A-6B) and a coaching voucher redemption module (FIGS. 7A-7C). Each of the components have with different participants and event records which are appended to the coaching voucher blockchain ledger. All three components are required to be executed fully in sequence in order to consider the coaching voucher complete and fully executed. Once the coaching voucher is in places, actual coaching of the recipient occurs as detailed in FIG. 8.

FIGS. 5A-5G illustrate the coaching voucher creation module between the user, the advisor and optionally a verification contact. FIG. 5A illustrates the coaching voucher creation blockchain 500 process. The advisor or user uses a computer program to create the coaching voucher agreement 510. The system creates a coaching voucher blockchain 520. The coaching voucher agreement is a blockchain with event record requirements of the system user, the recipient, the advisor and the verification contact. The advisor can facilitate the initial creation of the coaching voucher under the direction of the user. During the process of creating the coaching voucher, coaching participant information is provided 530, instructions are provided regarding tax implications 540, verification contact information is provided and approved 550, spousal approval, if needed, is obtained 560, the coaching voucher is personalized 570, and the user approves the final coaching voucher 580.

FIG. 5B illustrates steps for the coaching voucher participation information step 530. As an initial process personally identifiable information 531 for the user is provided. Once a user profile is set-up with personally identifiable information, one or more recipients 532 can be specified to receive the coaching voucher. One or more verification contacts 533 can also be identified. For example, different recipients may have different verification contacts. One or more advisors 534 is also identified. Typically, one advisor is identified per coaching voucher recipient. However, the system is not limited to one advisor per recipient or user. One or more sources of funds is also identified for each of the recipients 535. Once the information is provided, the coaching voucher participant block 536 is completed and appended to the coaching voucher creation blockchain 500 as shown in FIG. 5A.

FIG. 5C illustrates investment instructions and tax implications 540 completed by user and advisor and appended to the blockchain. In a first process, instructions, dollar amounts and withdrawal terms are provided 542. The instructions and withdrawal terms outline the conditions under which the recipient can instruct or withdraw funds from the account owned by the user. The recipient will also be required to review tax implications for the money funding the account 544. The recipient may be provided with the source of funds 546. Once the coaching voucher instruction block 548 is completed, the block is appended to the coaching voucher creation blockchain 500.

FIG. 5D shows a verification contact approval 550 process. This process is optional, and provides for the verification contact to receive a communication about the coaching voucher 552 and then to review agreements and submit approval of the agreements 554. Once the coaching voucher verification contact block 556 is complete, the block is appended to the coaching voucher creation blockchain 500. If the user does not specify a verification contact, a block for this process is not appended.

FIG. 5E illustrates a spousal approval 560 process for completion by the user and advisor and appended to the blockchain. As with the spousal approval illustrated in FIG. 2E a user spousal approval requirement process 560 is completed by user and advisor and appended to the blockchain. The user indicates marital status 561, if the user is married, then a spousal agreement is sent to the user's spouse 562, the spousal agreement is then executed by the spouse 563. If the user is unmarried, or the spousal agreement has been executed, a marital status inquiry is sent to the advisor 564. The advisor then confirms the marital status 565 as either married or unmarried. If the marital status is correct 566, then the spousal approval for coaching voucher block 568 is completed and appended to the coaching voucher creation blockchain 500 in FIG. 5A.

FIG. 5F shows user coaching voucher personalization 570 optional requirements completed by user and appended to the blockchain. Similar to the process shown in FIG. 2F a coaching voucher personalization can be completed by user and appended to the blockchain. If the user does not create and attach one or more personalized messages and other media the block is not created or appended. The personalize coaching voucher 570 process includes the user attaching one or more of a personalized audio, video, text, or other item for delivery to the recipient 572 when the coaching voucher is delivered to the recipient. Once the user creates the one or more personalized message, personalizing coaching voucher block 574 is completed and appended to the coaching voucher creation blockchain 500 in FIG. 5A.

FIG. 5G illustrates a user review and approval of the coaching voucher 580 and any other documents required for the recipient to successfully redeem the coaching voucher in the future. Each block can contain a document in a scanned format (i.e. pdf or jpg) which is appended in its entirety to a block. Alternatively, the user can sign electronically. In securing user approval, the user may review and sign one or more of: coaching voucher agreement 582, and authorization set-up form 584. Once the agreements are in place the user submits a final approval 586 and the user approval block is completed 588 and appended to the coaching voucher creation blockchain 500 in FIG. 5A.

FIGS. 6A-6B shows the coaching voucher delivery blockchain 600 process of the recipient receiving the coaching voucher. FIG. 6A shows a plurality of delivery actions the system executes and appends to the blockchain for during the coaching voucher delivery blockchain process, As a first step, the recipient receives a coaching voucher 610, e.g. an electronic voucher such as an email and/or text notification is sent to the recipient 620. The recipient then registers with the system 630. Registration can include downloading a mobile app or accessing a website. The recipient can receive personalized messages 640 from the user and other media as part of the coaching voucher. The recipient also receives redemption instructions 650 and legal documents. As each action occurs, a block is appended to the coaching voucher delivery blockchain 600.

FIG. 6B illustrates the redemption instructions 650 and legal documents process in FIG. 6A. During the redemption process a trade authorization set-up form 652 is reviewed and approved. Once all the forms are reviewed and approved, the coaching voucher is received by the recipient 660 and appended to the coaching voucher delivery blockchain 600 in FIG. 6A.

FIGS. 7A-7C shows a coaching voucher redemption blockchain 700 for the advisor, recipient and optionally a verification contact. As shown in FIG. 7A the advisor receives the coaching voucher 710 (e.g., the recipient delivers the coaching voucher 720). The steps from the delivery of the coaching voucher are appended to the coaching voucher redemption blockchain 700. The recipient and the advisor sign and review agreements 730 related to the coaching voucher. Entering into the agreements can be electronically, via smart contracts, or by submitting documents with signatures. The advisor submits trade authorization agreement 740 which is appended to the coaching voucher redemption blockchain 700 in FIG. 7A. Each agreement is reviewed and approved electronically by the appropriate party (e.g., user, recipient, etc.), after which the coaching voucher is redeemed 750. As will be appreciated by those skilled in the art, the redemption process can also include notification of the verification contact of the coaching voucher redemption process. Involving the verification contact can include steps and blockchain additions for verifying the identity of the recipient and/or advisor.

Turning to FIG. 7B, when the recipient delivers the coaching voucher 720. The advisor verifies the coaching voucher 722 and then verifies the recipient's identity 724. As noted above, identity verification can include requesting the verification contact to confirm the identity of the recipient. Once the advisor verifies the recipient's identity and completes requested documentation, the advisor redeems the coaching voucher 726 and the recipient delivery blockchain input 728 is completed and appended to the coaching voucher redemption blockchain 700 in FIG. 7A.

FIG. 7C illustrates additional process for the recipient and the advisor to review and complete agreements 730, e.g. sign, approve or authorize agreements. Entering into the agreements can be electronically, via smart contracts, or by submitting documents with signatures. Completing agreements includes, for example, a trade authorization set-up form 732 review and approval process. Once the agreement review block is completed 734 the block is appended to the coaching voucher redemption blockchain 700 in FIG. 7A.

Once the coaching voucher is redeemed and the accounts are set-up, the system can be configured to accommodate a coaching process occurs. The coaching process can occur with or without a blockchain record. Additionally, the coaching the blockchain process for coaching can occur within the disclosed system or as part of a separate system. FIG. 8 illustrates a coaching transaction blockchain 800. The coaching transaction can occur repeatedly during the duration of coaching. During coaching, the recipient submits a transaction request to the advisor 810. For example, instructions to buy 100 shares of a particular stock. A notification, such as email or text, is sent to the user 820 advising the user of the proposed action. The user then approves or declines the submitted transaction 830. If the user approves the instructions, then the instructions are provided to the advisor 840 for completion of the transaction. Each step of the process is appended to a coaching transaction blockchain 800. An additional process can also occur whereby the user responds to the recipient to explain why the proposed transaction was approved or declined.

In another configuration of the coaching voucher shown in FIG. 8, the recipient submits a transaction request to the advisor. A notification or communication, such as email or text, is sent to the advisor requesting the proposed action. The advisor then approves or declines the submitted transaction. If the advisor approves the transaction, then the transaction is completed. Each step of the process is appended to a coaching blockchain. An additional process can also occur whereby the advisor responds to the recipient to explain why the proposed transaction was approved or declined.

### VI. Trust Overview

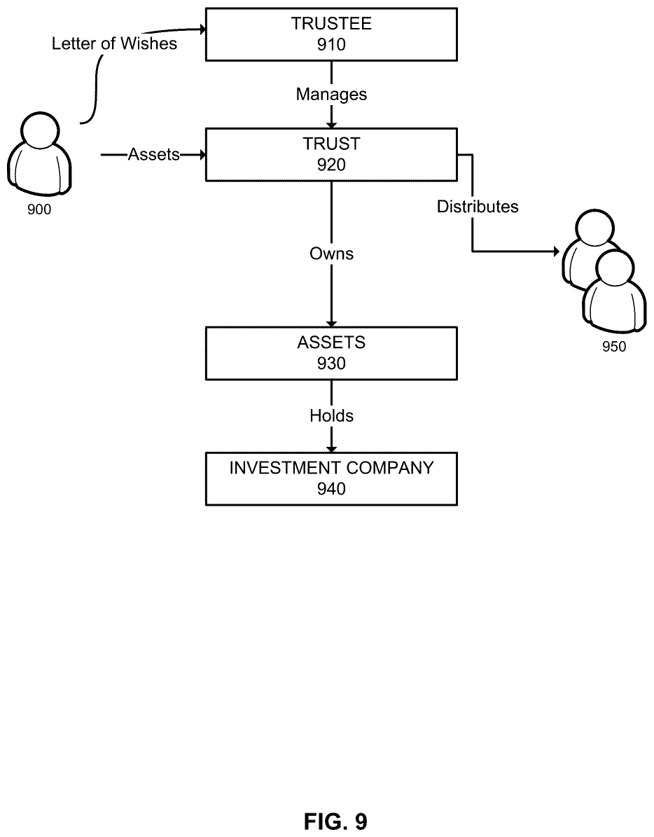

FIG. 9 illustrates an exemplar flow of information from a donor 900 (e.g., the person or user establishing a trust) and a trust 920. The donor 900 creates the trust and transfers initial assets 930 (e.g., cash and real property) to the trust. A letter of wishes is provided to the trustee 910. The trust owns the assets 930. Where cash or stocks are involved, an investment company 940 can hold the assets 930 for the trust. Upon occurrence of an event, the trust 920 distributes assets 930 from the trust 920 to the beneficiaries 950 (or recipients) of the trust. An investment company 940 typically has advisors (such as wealth managers) that interface with customers, including donors, users, beneficiaries, recipients, verification contacts, trustees (e.g., trust administrators), and other parties.

A variety of trusts are available; trusts typically fall into one of two categories: revocable or irrevocable. A revocable trust is a trust with provisions that can be altered or canceled dependent on the grantor or the originator of the trust (i.e., donor 900). During the life of the revocable trust, income earned can be distributed to the grantor, and only after death does property transfer to the beneficiaries of the trust. In contrast, an irrevocable trust is a trust where its terms cannot be modified, amended or terminated without the permission of the grantor's named beneficiary or beneficiaries.

### VII. Distribution System Overview

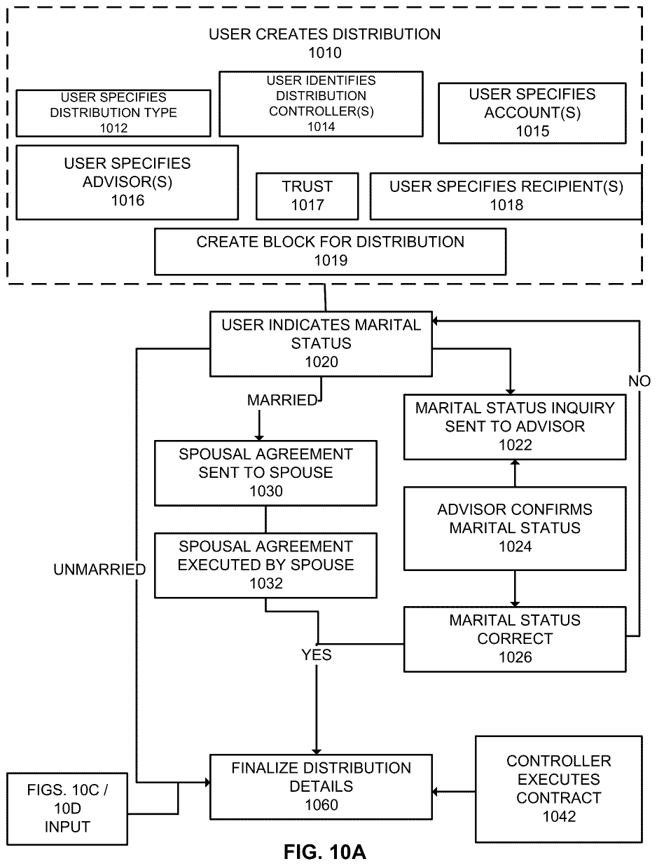

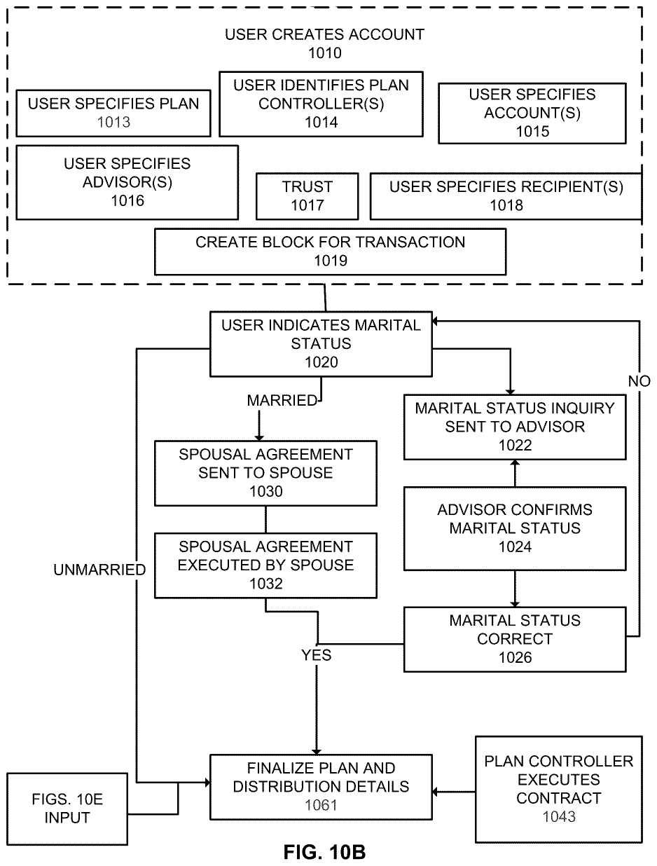

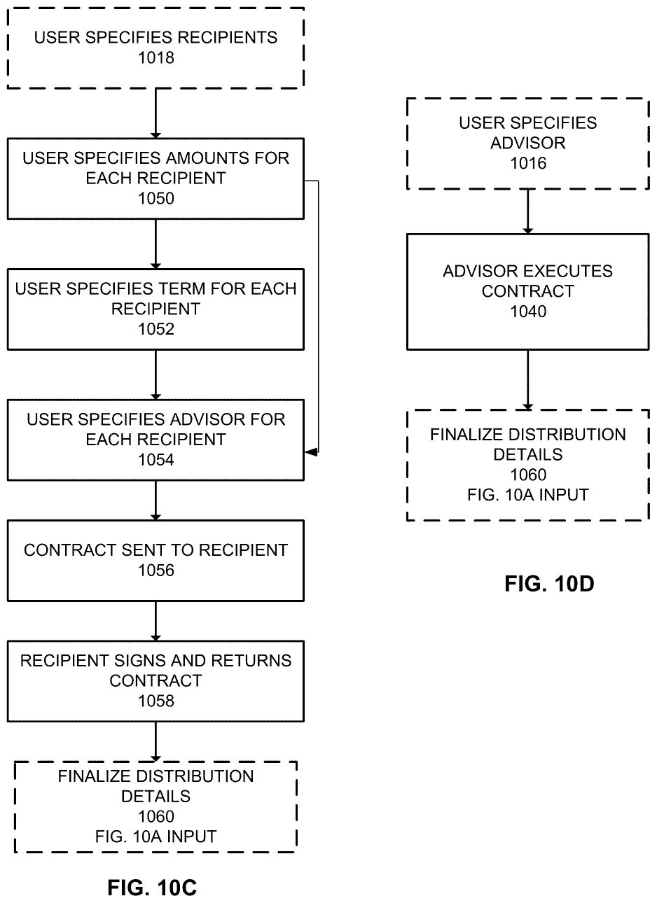

Turning to the disclosed distribution system, in an initial process shown in FIG. 10A, a user creates a distribution 1010 for a trust within the system. During the distribution creation process, the user specifies a distribution type 1012, identifies one or more controllers 1014, specifies one or more accounts 315 to be accessed or associated with a distribution, identifies one or more advisors 1016, and identifies one or more recipients 1018. During this process, the system creates a block for the blockchain for each distribution 1019. The user also identifies the trust 1017. The controller 1014 is responsible for performing duties associated with managing the distribution via the trust until the final date for distribution occurs.

The distribution system can be a service provider that has a variety of system participants including but not limited to: the account holder (user), the recipient, the beneficiary, the controller, the advisor, the spouse, the verification contact, etc.

During the distribution set-up process, the user can also indicate a marital status 1020. If the user is married, then information about the spouse is entered into the distribution system and a spousal consent agreement is sent electronically to the spouse 1030. In one configuration, the spouse prints the authorization, signs the authorization 1032 in front of a witness or Notary Public, and then returns an electronic copy of the completed document. Return of the electronic copy can occur by any suitable process including, for example, uploading a photo of the signed document via a mobile device. The system can then review the document for legibility to ensure the document appended is the authorization and the information required is present and legible. If the information is not legible, the system can flag the document for human review and/or notify the person uploading the document that the quality of the document is not sufficient. In another configuration, the spouse creates an account with the system and accesses an electronic version of the consent agreement. The spouse is then given the opportunity to accept or reject the agreement. In order to complete the acceptance biometric data, such as a fingerprint, may be required. Thus, for example, in a mobile environment, the spouse would choose, for example, accept and then be required to swipe a known finger across the fingerprint sensor embedded in the phone.

Once the user identifies an advisor and indicates a marital status, a notification is sent to the advisor notifying the advisor that the advisor has been identified as the advisor for the user in the distribution system and requesting the advisor confirm or indicate a marital status 1022 for the user. In response to the marital status inquiry 1022, the advisor confirms the marital status 1024. In one configuration, for example, the advisor can be presented with an option such as “John Smith-married” with a “confirm YES/NO” option. In another configuration, the advisor can be required to independently indicate a marital status for the user. Once the advisor indicates the marital status of the user, the distribution system determines if the marital status is correct 1026 by either determining that the advisor has indicated a positive confirmation or has entered the same marital status as the user. If the marital status is correct 1026 (YES), then the process proceeds to completion. If the marital status is not correct (NO), then the distribution system notifies the user and requests the information be updated.

If the user is unmarried and the advisor confirms 1024 that the user in unmarried, then the distribution details are finalized and the controller executes the contract 1042. The controller can have limited or restricted permissions. Permissions for the controller can be set to change upon the occurrence of one or more defined events (e.g., incapacity or death of the user or a date certain or date of any identified triggering event). Once all the components are completed, the distribution is finalized and distribution details are completed 1060.

In FIG. 10B, a process of the user identifying recipients 1018 is provided in further detail. Once one or more recipients are identified by the user in the distribution system, the user specifies an amount for each distribution recipient 1050. The amount becomes associated with a distribution. The user identifies an advisor for each distribution 1054. A contract is sent to the distribution recipient 1056 identifying the amount and any conditions. The distribution recipient signs and returns the contract 1058. Once the distribution recipient signs and returns the contract, the information is provided to the blockchain and the finalized distribution process 1060. The process of the user specifying recipients 1018 can result in separate blocks of the blockchain for each of the recipients.

The controllers 1014 act as administrators and can be set-up as a primary administrator and a back-up administrator. The controllers can be set-up at the account level or the recipient level. In the event the recipient has an action coming due, or a disbursement coming due and the system does not receive confirmation from the recipient, the primary administrator will be advised. Once the primary administrator receives notification of a required action for the administrator, the primary administrator can interact with the recipient to ensure the recipient engages with the system as needed for the event. The administrator may also provide feedback to the system regarding the recipient. In some configurations, the administrator has no control over the funds or their distribution in the system.

In another configuration, the distribution recipient is only notified of the amount and conditions of the intended gift. Notification can occur at the time the user sets-up the account or when an event occurs that results in a distribution. The distribution provides that the specified amount will be placed into an investment account with the advisor for benefit of the user for a period of time after a triggering event, e.g., death of the user. The user can also specifies a term for the distribution 1052. For example, the account with the advisor needs to be opened within a period of time from defined event occurrences, and/or held for 12 months, 18 months, etc. The distribution can also be made over a period of time at regular intervals (e.g., monthly or yearly). The process of identifying recipients can be instructed by the user or the controller.

Where the distribution recipient signs and returns the contract 1058, return of the electronic copy can occur by any suitable process including, for example, uploading a photo of the signed document via a mobile device.

The system can then review the document for legibility to ensure the document appended is the authorization and the information required is present and legible. If the information is not legible, the system can flag the document for human review and/or notify the person uploading the document that the quality of the document is not sufficient. In another configuration, the distribution recipient creates an account with the system and accesses an electronic version of the distribution agreement. The distribution recipient is then given the opportunity to accept or reject the distribution recipient agreement. In order to complete the acceptance biometric data, such as a fingerprint, may be required. Thus, for example, in a mobile environment, the distribution recipient would choose accept and then be required to swipe a known finger across the fingerprint sensor embedded in the phone. In another configuration, the distribution recipient can print the distribution recipient agreement, sign the agreement in the presence of a Notary Public and then upload a copy of the signed distribution agreement into the system.

Turning now to FIG. 10D, the advisor executes a contract 1040 agreeing to manage the investment for the distribution recipient. Once the advisor executes the contract, the information is provided to the blockchain and the finalized distribution process 1060.

The system is also configurable to provide a news feed to each participant. The newsfeed advises of upcoming actions and provides for a regular request for update (e.g., annual update request). Alerts and notifications can be provided via the system newsfeed, via text message, via push notification, via email, or any other suitable available mechanism.

Once the one or more defined events occur, specified accounts associated with the system receive a notice. The distribution can be funded from any or all of: the user's estate, the user's administrative trust (former revocable trust), any user's pay on death account, or as a distribution recipient of any of the user's life insurance policies. A similar process could occur in the event of incapacity, as will be appreciated by those skilled in the art. In other implementations, the planned event can be an event such as a college graduation, a 21^{st} birthday, or other date certain or verifiable event.

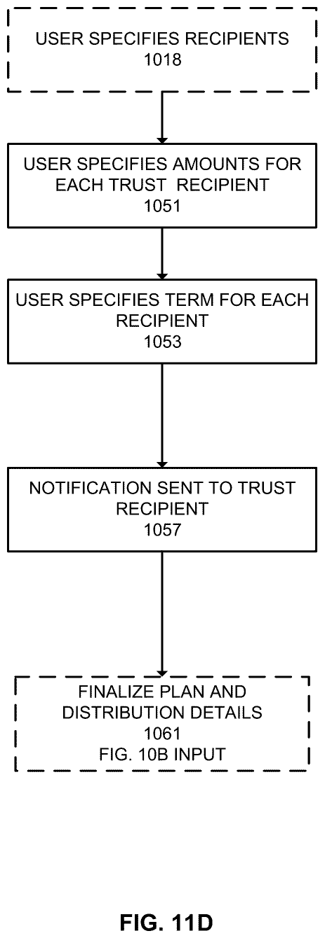

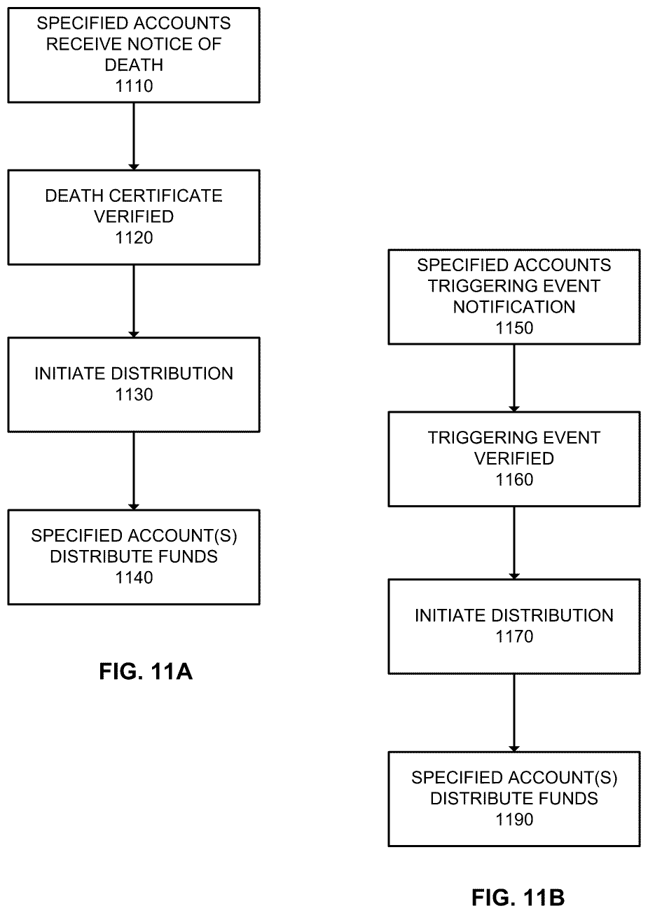

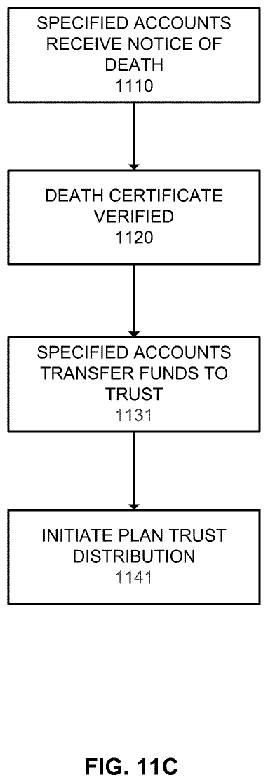

Turning to FIGS. 11A-B, the specified account receives a notice of death 1110, for example, or a notice of a triggering event 1150. Next, the death certificate is verified 1120 or the occurrence of the triggering event is verified 1160. Once verification occurs, e.g., via determining a digital certificate for proving authenticity, distribution is initiated 1130, 1170, and then the funds are distributed 1140, 1190.

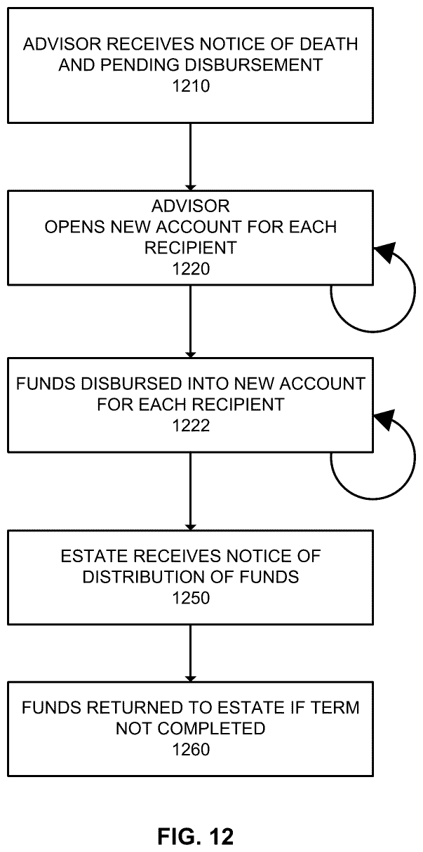

As shown in FIG. 12, once the distributions are initiated, the advisor receives, for example, a notice of death and pending disbursement 1210 via the distribution system. As will be appreciated from the disclosure above, the notice can also be a notice of the occurrence of a triggering event identified as part of the distribution (e.g., date certain, completion of a triggering or qualifying event). The notice received or generated (in the case of a date certain) via the distribution system may be in addition to any notice that the advisor receives outside of the distribution system. Once the notice is received, the advisor opens a new account for each distribution recipient 1220 associated with the advisor. Funds are then disbursed into the new accounts 1222 for the distribution recipient and the controller (e.g., administrator or trustee) for the estate receives a notification of the distribution of funds 1250. The account is subject to forfeiture if the recipient does not maintain the account for the term specified.

### VIII. Distribution Examples

### Example 1

In a first example, the distribution system user has set-up a legal trust as shown in FIG. 9. The user then enters into an agreement (i.e. contracts) with the distribution system provider to administer a distribution through the trust. The funds for the distribution are distributed from the trust that the user has set-up to the distribution system upon, for example, death of the user. The distribution is transmitted to the advisor identified by the user for the benefit of the distribution recipient.

The distribution recipient is a third-party beneficiary to the agreement between the user and the distribution system provider. In order to receive the benefit of the agreement between the user and the distribution system provider, the distribution recipient is required to open an investment account for the funds with the advisor identified. In some configurations, the recipient may be required to maintain the account for the period of time specified in the agreement between the user and the distribution system provider. If the recipient violates the terms of the agreement, the funds can, for example, revert back to the trust and/or the estate of the user.

### Example 2

In another example, the distribution system user has set-up a distribution as shown in FIGS. 10A-B. The user then enters into an agreement (i.e. contracts) with the distribution system provider to administer a distribution. The funds for the distribution are distributed from a source that the user has set-up to the distribution system upon a date certain, such as the 21^{st} birthday of the recipient. The distribution is transmitted to the advisor identified by the user for the benefit of the distribution recipient upon the occurrence of the event.

The distribution recipient is a third-party beneficiary to the agreement between the user and the distribution system provider. In order to receive the benefit of the agreement between the user and the distribution system provider, the distribution recipient is required to open an investment account for the funds with the advisor identified. In some configurations, the recipient may be required to maintain the account for the period of time specified in the agreement between the user and the distribution system provider. If the recipient violates the terms of the agreement, the funds can, for example, revert back to the estate of the user.

### Example 3

In another example, the distribution system user has set-up a distribution as shown in FIG. 10A-B. The user then enters into an agreement (i.e. contracts) with the distribution system provider to administer a distribution. The funds for the distribution are distributed from a source that the user has set-up to the distribution system upon the occurrence of an event, such as matriculation from an educational program of the recipient. The distribution is transmitted to the advisor identified by the user for the benefit of the distribution recipient upon the evidence of the occurrence of the event.

The distribution recipient is a third-party beneficiary to the agreement between the user and the distribution system provider. In order to receive the benefit of the agreement between the user and the distribution system provider, the distribution recipient is required to open an investment account for the funds with the advisor identified. In some configurations, the recipient may be required to maintain the account for the period of time specified in the agreement between the user and the distribution system provider. If the recipient violates the terms of the agreement, the funds can, for example, revert back to the trust and/or estate of the user.

### Example 4

In another example, the distribution system user has set-up a distribution as shown in FIG. 10A-B. The user then enters into an agreement (i.e. contracts) with the distribution system provider to administer a distribution. The user updates distribution instructions over time at the user's discretion.

### Example 5

In another example, the distribution system user has set-up a distribution as shown in FIG. 10A-B. A distribution is triggered and the recipient and/or one or more controllers (administrators) are notified. In the event the recipient does not respond to the notification, the one or more controllers are requested to facilitate distribution to the recipient or release of recipient funds.

### IX. Trust Distribution System Overview

Turning to the disclosed trust distribution system, in an initial process shown in FIG. 10C, a user creates an account 1010 within the system. The user is a person creating a trust. During the account creation process, the user specifies a plan 1013, identifies one or more plan controllers 1014, specifies one or more accounts 1015 to be accessed, identifies one or more advisors 1016, and identifies one or more recipients 1018. During this process, the system creates a block for the blockchain for this transaction 1019. The user can also designates whether any of the identified accounts are, or will be, associated with the trust 1017. The plan controller 1014 is a trust administrator responsible for performing duties associated with disposing of an estate for the user once the user is deceased.

The controllers 1014 can act as administrators and can be set-up as a primary administrator and a back-up administrator. The controllers can be set-up at the account level or the recipient level. In the event the recipient has an action coming due, or a disbursement coming due and the system does not receive confirmation from the recipient, the primary administrator will be advised. Once the primary administrator receives notification of a required action for the administrator, the primary administrator can interact with the recipient to ensure the recipient engages with the system as needed for the event. The administrator may also provide feedback to the system regarding the recipient. In some configurations, the administrator has no control over the funds or their distribution in the system.

During the set-up process, the user also indicates a marital status 1020. If the user is married, then information about the spouse is entered into the trust distribution system and a spousal consent agreement is sent electronically to the spouse 1030. In one configuration, the spouse prints the authorization, signs the authorization 1032 in front of a witness or Notary Public, and then returns an electronic copy of the completed document. Return of the electronic copy can occur by any suitable process including, for example, uploading a photo of the signed document via a mobile device. The trust distribution system can then review the document for legibility to ensure the document appended is the authorization and the information required is present and legible. If the information is not legible, the trust distribution system can flag the document for human review and/or notify the person uploading the document that the quality of the document is not sufficient. In another configuration, the spouse creates a separate account with the trust distribution system and accesses an electronic version of the consent agreement. The spouse is then given the opportunity to accept or reject the agreement. In order to complete the acceptance biometric data, such as a fingerprint, may be required. Thus, for example, in a mobile environment, the spouse would choose accept and then be required to swipe a known finger across the fingerprint sensor embedded in the phone.

In one configuration the user identifies an advisor or bank holding cash assets for the user and indicates a marital status. A notification is then sent to the advisor or bank requesting the advisor or bank confirm or indicate a marital status 1022 for the user. In response to the marital status inquiry 1022, the advisor or bank confirms the marital status 1024. In one configuration, for example, the advisor or bank can be presented with an option such as “John Smith-married” with a “confirm YES/NO” option. In another configuration, the advisor or bank can be required to independently indicate a marital status for the user. Once the advisor or bank indicates the marital status of the user, the trust distribution system determines if the marital status is correct 1026 by either determining that the advisor has indicated a positive confirmation or has entered the same marital status as the user. If the marital status is correct 1026 (YES), then the process proceeds to completion. If the marital status is not correct (NO), then the trust distribution system notifies the user and requests the information be updated. Where the spousal confirmation is sent to a bank, an authorized user of the bank or other bank approved process can be applied.

If the user is unmarried and the advisor or bank confirms 1024 that the user in unmarried, then the plan and distribution details are finalized 1061 and the plan controller executes the contract 1043. The plan controller can have limited or restricted permissions. Permissions for the plan controller can be set to change upon the occurrence of one or more defined events (e.g., incapacity or death of the user). Once all the components are completed, the plan is finalized and distribution details are completed 1061.

In FIG. 10C, a process of the user identifying recipients 1018 is provided in further detail. Once one or more recipients are identified by the user in the trust distribution system, the user specifies an amount for each recipient 1050. A notification can be sent to each recipient at the time the user creates the trust, or upon the occurrence of a qualifying event, indicating that they are identified in the trust distribution system and requesting the recipient confirm contact details.

The process of the user specifying recipients 1018 can result in separate blocks of the blockchain for each of the recipients. Any recipient confirmation of contact information can also create blocks of the blockchain.

The user can also specify a term for the distribution 1052. For example, the account with the advisor needs to be opened within a period of time from defined event occurrence, i.e. death of the user setting up the trust, and/or held for 12 months, 18 months, 10 years, etc. The process of identifying recipients can be instructed by the user or the plan controller.

The system can review the any documents that are submitted for legibility to ensure the document appended is the authorization and the information required is present and legible. If the information is not legible, the system can flag the document for human review and/or notify the person uploading the document that the quality of the document is not sufficient.

The system is also configurable to provide a news feed to each participant. The newsfeed advises of upcoming actions and provides for a regular request for update (e.g., annual update request). Alerts and notifications can be provided via the system newsfeed, via text message, via push notification, via email, or any other suitable available mechanism.

Turning to FIG. 11C, unless the trust is revocable and the user terminates the trust early, once the specified accounts associated with the trust distribution system receive a notice of death the process of trust distribution begins. For example, specified accounts receive a notice of death 1110. The death certificate is verified 1120. If the funds re not already transferred to the trust, the specified accounts transfer funds to the trust 1131 and the plan distribution are initiated for the beneficiaries 1141. The beneficiary's funds can be provided from any or all of: the user's estate, the user's administrative trust (former revocable trust), any user's pay on death account, or as a recipient of any of the user's life insurance policies. A similar process could occur in the event of incapacity of the user, as will be appreciated by those skilled in the art.

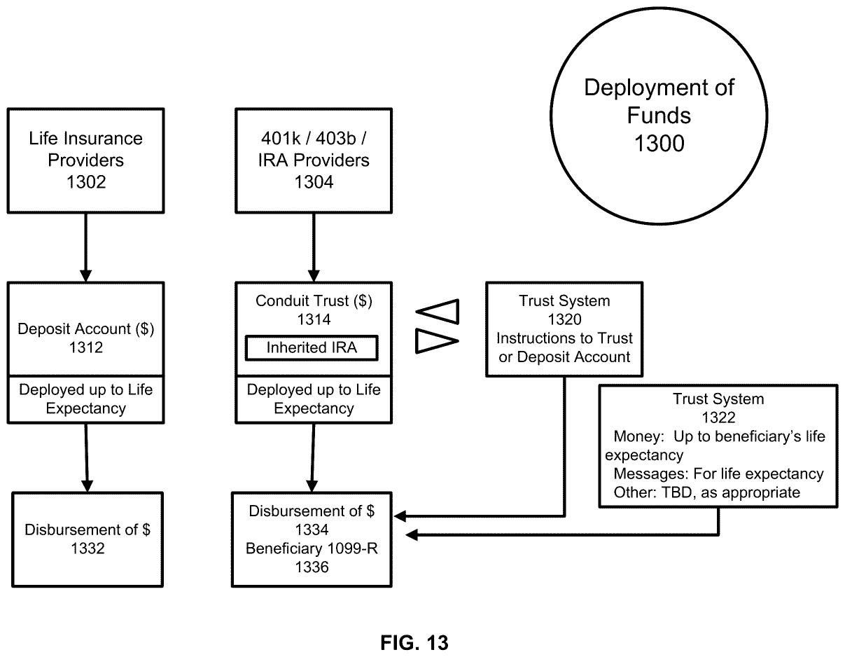

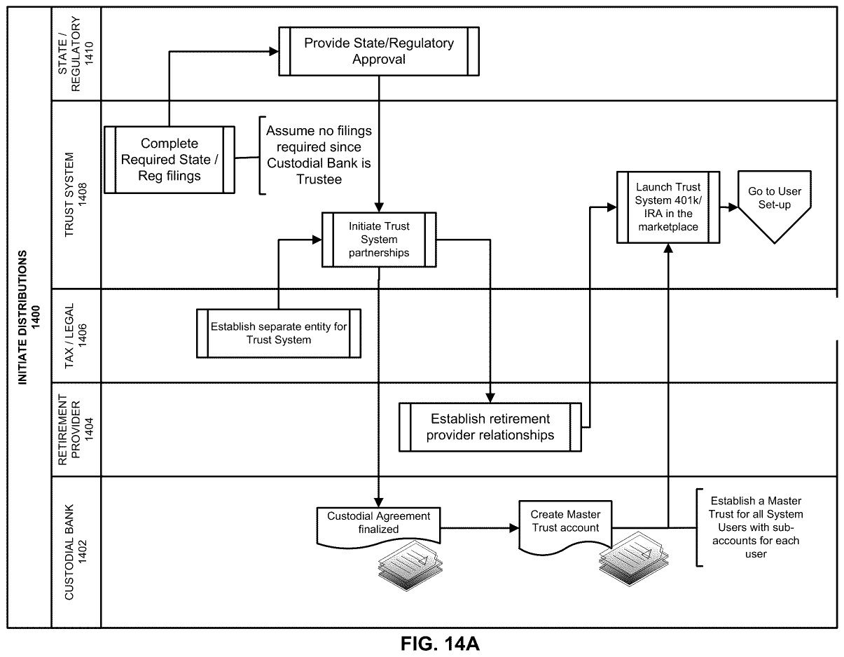

FIG. 13 is a deployment of funds 1300 process. In one aspect one or more life insurance provers 1302, such as State Farm®, Northwestern Mutual®, Prudential® or New York Life®, deposits money into a deposit account 1312. The money deposited is deployable by the trust distribution system up to the life expectancy of the recipient, or over any time frame designated by the trust. Money can be disbursed 1332 from the account 1312.

In another aspect one or more retirement account providers, such as JP Morgan Chase®, Fidelity®, Vanguard®, Prudential®, or Transamerica®, deposit funds into a conduit trust 1314 which is manageable up to the life of the recipient, or over any time frame designated. Funds are disbursable from the conduit trust 1314 to the recipient via the trust distribution system. Money, such as money inherited from an IRA, is disbursed 1336 and beneficiaries receive appropriate tax forms, e.g. 1099-R forms. The trust distribution system is configurable to provide instructions 1320 to a trust account or deposit account. Additionally, the trust distribution system can provide messages 1322 to the beneficiary with the disbursement or arrange for appropriate tax forms, e.g., Beneficiary 1099-R, to be provided 1336.

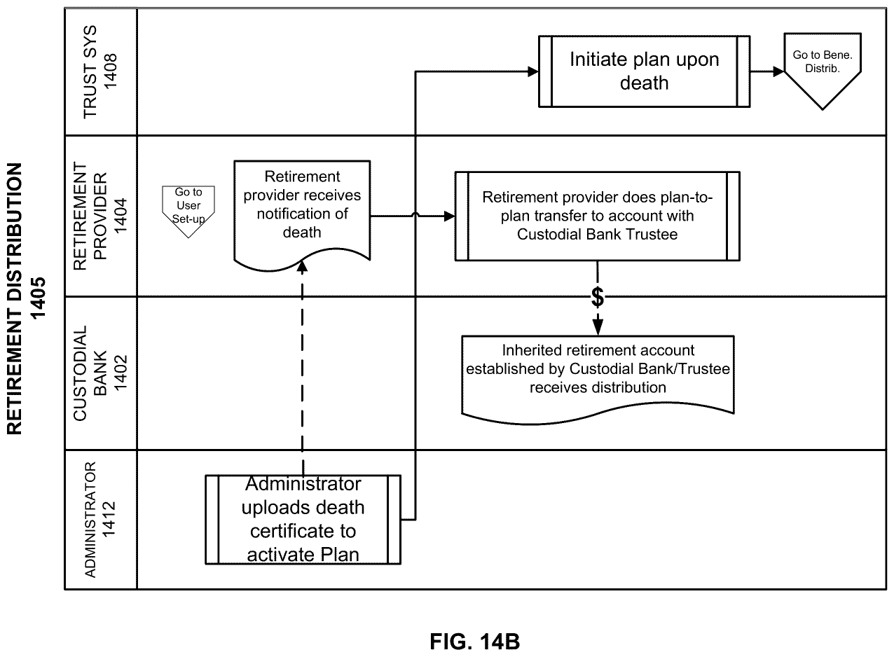

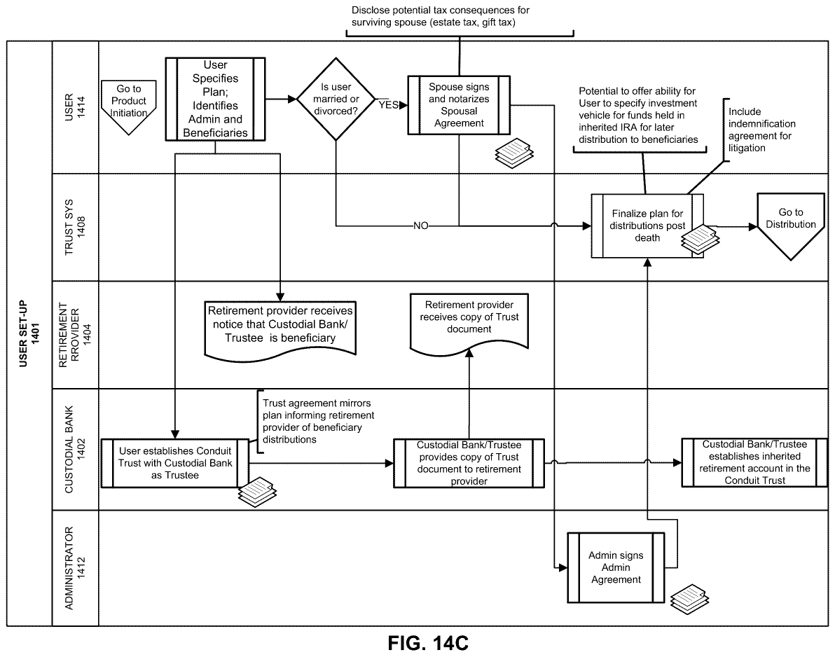

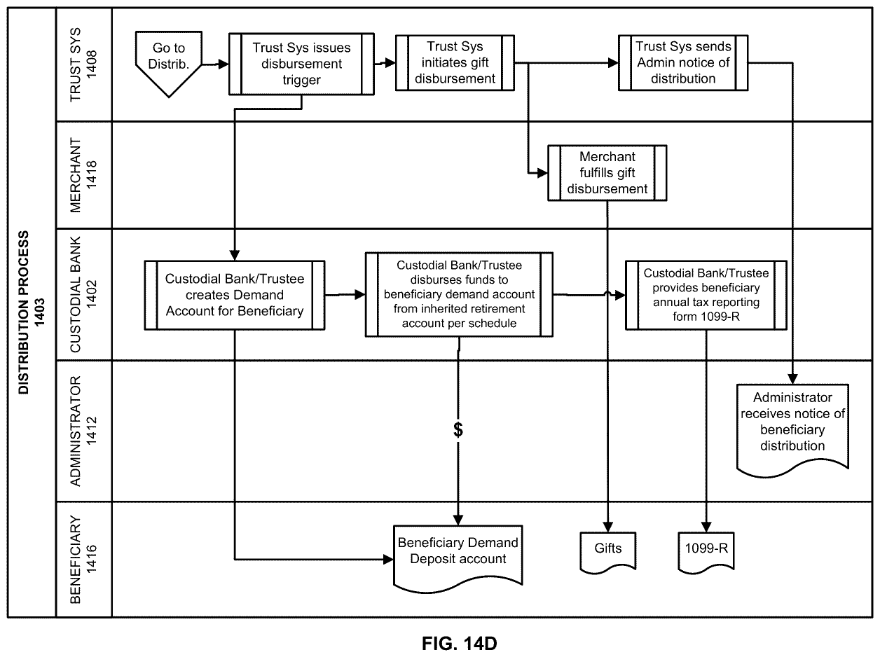

FIGS. 14A-14D are distribution flow diagrams for the trust distribution system. FIG. 14A illustrates an exemplar retirement account distribution process where a user designates a custodial entity (e.g., bank) as trustee to receive funds from the user's retirement account (e.g., IRA, 401k, 403b, etc.) upon death of the user. The funds are then distributed via the disclosed trust distribution system.

The flow diagrams illustrates actions that occur for different users of the trust distribution system over time. Distribution can be initiated 1400 from different users including, custodial bank 1402, retirement provider 1404, tax and/or legal processes 1406, trust distribution system 1408, state and/or regulatory processes 1410, administrator 1412, user 1414, beneficiary 1416, and merchant 1418.

The custodial bank 1402 is the bank, or other suitably qualified entity, that holds and or handles money or assets to be distributed by for the user by the trust distribution system. The custodial bank 1402 can be a bank or trust company selected by the User/Benefactor and the Beneficiary at which the Beneficiary will establish an account into which proceeds of insurance on the life of the User/Benefactor or his or her 401(k)/403(b)/IRA retirement benefits will be made payable following his or her death.

The retirement provider 1404 is the financial institution, or other suitably qualified entity, that manages and/or administers assets and/or retirement benefits in a retirement account for the user.

The tax and/or legal processes 1406 is any process conducted with respect to any reporting requirements to the US Federal and US state tax authorities relating to the payment, receipt and disbursement/administration of any life insurance proceeds and/or retirement benefits.

The trust distribution system 1408 is the trust distribution disclosed herein.

The state and/or regulatory processes 1410 include any processes undertaken with respect to regulation of any bank or trust company, or suitably qualified entity, that will receive and/or administer insurance proceeds or 401(k)/403(b)/IRA retirement benefits in accordance with any custodial or trust agreement.

The administrator 1412 is the trust distribution system disclosed or a designee of the trust distribution system that will direct payment of funds in any bank or trust account to the beneficiaries.

The user 1414, is the user of the trust distribution system that has established a trust, identified assets and named beneficiaries as disclosed herein. The user is also the benefactor or donor as shown in FIG. 9.

The beneficiary 1416, is any person or entity that the user identifies to receive proceeds from life insurance policies and/or 401(k)/403(b)/IRA retirement benefits.

The merchant 1418 is a seller or provider of merchandise or services that the user may want to deliver merchandise or services after his or her death to one or more beneficiaries. Provision of merchandise or services can be in addition to, or in lieu of, life insurance proceeds or 401(k)/403(b)/IRS retirement benefits.

The flow diagram in FIG. 14A illustrates a distribution process. If needed the trust distribution system completes any required state or regulatory filings. The state and regulatory filings are configurable to await approval (if required) from the corresponding state or regulatory authority. Where a custodial bank is trustee, then no filing is likely required. Once any approval that is required is obtained, or where no approval is required, the trust distribution system can initiate partnerships. A separate entity, e.g., a conduit trust, can be established for the trust distribution system.

As will be appreciated by those skilled in the art, a trust distribution system would be required with respect to a bequest of the User/Benefactor's 401(k)/403(b)/IRA retirement benefits, because those benefits would have to be distributed to an “inherited IRA, from which they would be paid out to a qualified trust, such as a so-called “conduit trust,” of which the Beneficiary would be the sole beneficiary and receive payments over his or her life expectancy as of the date of the User/Benefactor's death, in order to qualify for income tax deferral for the benefits. A conduit trust is a separate entity for income tax purposes, but the benefits may be taxable to the beneficiary when paid to him or her and deductible by the trust.

Once the trust distribution system partnerships are initiated, the custodial bank can finalize any custodial agreements required, and the retirement provider can establish retirement provide relationships. After the custodial agreements are finalized, a master trust account is created for all system user with sub-accounts for each user. The trust distribution system is then launched in the marketplace. Following that process a user set-up process, such as shown in FIG. 14C, can be initiated.

Turning to FIG. 14B, a retirement account distribution 1405 upon death process is illustrated. The retirement provider receives notification of death of the account holder (e.g., from the administrator) and transfers the funds from the retirement account to an account with the identified custodial bank trustee. The administrator uploads a death certificate to activate the plan at which point the plan is initiated and the process proceeds to the beneficiary distribution process, such as shown in FIG. 14D.

FIG. 14C illustrates a user set-up 1401. The user specifies a plan, identifies one or more plan administrators and one or more beneficiaries. The user indicates a marital status. If required, the spouse completes a spousal agreement. The spousal agreement can be notarized or legalized as needed or desirable. The spouse may also be advised of potential consequences of the plan, e.g., tax consequences. The user establishes a conduit trust with a custodial bank as trustee. The trust agreement mirrors plan and informs the retirement provider of the beneficiary distributions. The custodial bank/trustee provides a copy of trust documents to the retirement provider and the custodial bank/trustee establishes an inherited retirement account in the conduit trust.

Turning to FIG. 14D, a money and gift distribution process 1403 is shown. The custodial bank and/or trustee creates one or more demand accounts for one or more beneficiaries. The custodial bank and/or trustee disburses funds to one or more beneficiary demand accounts from an inherited retirement account per a schedule. The schedule can be provided by the owner of the account prior to death. The custodial bank and/or trustee then provides appropriate tax forms such as 1099-R. The trust distribution system is configurable to issue disbursement triggers, initiate one or more gift disbursements, and send one or more notices of distribution to, for example, an administrator. One or more merchants can fulfill one or more gift disbursements. A deposit account, gifts and/or 1099-R can be received by the beneficiary. In addition to, or instead of a gift, the system can send a voice or video message or electronic communication later in time following the same process as the gift disbursement.

### X. Trust Distribution Examples

### Example 1

In a first example, the trust distribution system user has set-up a legal trust as shown in FIG. 9. The user then enters into an agreement (i.e. contracts) with the trust distribution system provider to administer the trust. The funds for the trust are distributed from the trust that the user has set-up to the trust distribution system upon death of the user. The funds are distributed to recipients as outlined in the trust by the user, e.g., $5,000 per month for 10 years, etc.

### Example 2

A user sets-up a legal trust as shown in FIG. 9. In addition to the fund distribution process the user identifies a variety of gifts to be delivered at a future time to one or more beneficiaries (e.g., a string of pearls for a daughter's 21st birthday, a leather briefcase for projected college graduation, etc.).

### Example 3

A user sets-up a legal trust as shown in FIG. 9. In addition to the fund distribution process the user creates written, audio or video messages to be delivered at a later time by the system to one or more beneficiaries.

The processes illustrated in FIGS. 2-14 can be part of a computer program product for administering a voucher within a blockchain distributed network is disclosed. The computer program product for administering a voucher comprises at least one non-transitory computer-readable medium having computer-readable program code portions embodied therein, the computer-readable program code portions comprising: an executable portion configured to receive a request from a user utilizing a node to access the blockchain, wherein the request includes received authentication credentials, wherein the blockchain network comprises a distributed network of nodes managed by one or more entities, wherein nodes from the distributed network of nodes are operatively coupled to each other, have at least a portion of a ledger, and share information on the ledger through electronic communication, and wherein the received authentication credentials comprises user authentication credentials and node authentication credentials; an executable portion configured to compare the received authentication credentials with stored authentication credentials for the user and the node; an executable portion configured to allow the user to access the blockchain distributed network when the received authentication credentials meet the stored authentication credentials for the user and the node; an executable portion configured to determine one or more types of actions that the user is allowed to, or prevented from, taking based on the comparison of the received authentication credentials with the stored authentication credentials; an executable portion configured to receive an indication that the user took an action for an event within the blockchain, wherein the action occurred on the node from the distributed network of nodes, and wherein the action is validating the event using event information on the ledger of the node from the distributed network of nodes of the blockchain, storing the event information for the event on the ledger of the node from the distributed network of nodes of the blockchain, or disseminating the event information for the event on the ledger of the node to one or more other nodes of the distributed network of nodes of the blockchain; an executable portion configured to determine limits, wherein the limits comprise one or more user limits, one or more node limits, one or more entity limits, one or more event limits, and one or more action limits; an executable portion configured to compare the action taken and the user, the node, an entity associated with the user, and the event associated with the action to the limits, including the one or more user limits, the one or more node limits, the one or more entity limits, the one or more event limits, and the one or more action limits; and an executable portion configured to allow or deny the action based on the determination of the one or more types of actions that the user is allowed to, or prevented from, taking based on the comparison of the received authentication credentials with the stored authentication credentials and based on the comparison of the action and the user, the node, the entity, and the event associated with the action to the limits.

Identity verification on the current user who operates the account is performed to effectively control the risk of fraud with respect to the account. Furthermore, operation permission of an authorized user can be specified to allocate permission for the account. In addition, proxy permission information can be stored in the blockchain, and therefore it can be effectively ensured that the permission is trusted, thereby alleviating problems associated with a centralized node and access costs.

In an implementation, when receiving a permission query message from the system, the server can communicate with a first client, to verify the identity of the current user. For example, the server can send permission query task information to the service system, and the permission query task information instructs to invoke the first client. As such, the service system can invoke the first client based on the permission query task information. For example, the service system can prompt the current user to scan a code by using the end-user device of the current user to start the first client or by submitting a biometric (such as a fingerprint). Alternatively, the system can push a message, such as a text, for starting the first client to the end-user device of the current user, and then starts the first client based on acknowledgement input of the current user.

The verification information can include an authorization code. For example, the server can send an authorization instruction to the first client. The authorization instruction can be used to request the authorization code. For example, the authorization instruction can include a server time, an identifier of a channel, a challenge code, and a quantity of bits of the authorization code. The server then can receive the authorization code from the first client. The authorization code can be generated by the first client based on the authorization instruction and a client token. The channel can represent the use of the authorization code. For example, in the present specification, the channel can be used to represent that the authorization code is used to verify an identity. The challenge code can be a random code for ensuring security of a channel for sending the authorization instruction, for example, is used to place a request for replay and tampering.

For example, the authorization code can be generated based on an HMAC-based one-time password (HOTP) algorithm. For example, the authorization code can be generated by using the HOTP algorithm based on the client token, the identifier of the channel, the server time, the quantity of bits of the authorization code, and a value of the challenge code.

### XI. Computing Environment Overview

The systems and methods according to aspects of the disclosed subject matter may utilize a variety of computer and computing systems, communications devices, networks and/or digital/logic devices for operation. Each may, in turn, be configurable to utilize a suitable computing device that can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as an iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web browser, e.g., to provide access to applications and data and other content located on a website or a webpage of a website.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method that may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at sometimes be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

Additionally, a communication system of the disclosure comprises: a sensor as disclosed; a server computer system; a measurement module on the server computer system for permitting the transmission of a measurement from a detection device over a network; at least one of an API (application program interface) engine connected to at least one of the detection device to create a message about the measurement and transmit the message over an API integrated network to a recipient having a predetermined recipient user name, an SMS (short message service) engine connected to at least one of the system for detecting physiological parameters and the detection device to create an SMS message about the measurement and transmit the SMS message over a network to a recipient device having a predetermined measurement recipient telephone number, and an email engine connected to at least one of the detection device to create an email message about the measurement and transmit the email message over the network to a recipient email having a predetermined recipient email address. Communications capabilities also include the capability to communicate and display relevant performance information to the user, and support both ANT+and Bluetooth Smart wireless communications. A storing module on the server computer system for storing the measurement in a detection device server database can also be provided. In some system configurations, the detection device is connectable to the server computer system over at least one of a mobile phone network and an Internet network, and a browser on the measurement recipient electronic device is used to retrieve an interface on the server computer system. In still other configurations, the system further comprising: an interface on the server computer system, the interface being retrievable by an application on the mobile device. Additionally, the server computer system can be configured such that it is connectable over a cellular phone network to receive a response from the measurement recipient mobile device. The system can further comprise: a downloadable application residing on the measurement recipient mobile device, the downloadable application transmitting the response and a measurement recipient phone number ID over the cellular phone network to the server computer system, the server computer system utilizing the measurement recipient phone number ID to associate the response with the SMS measurement. Additionally, the system can be configured to comprise: a transmissions module that transmits the measurement over a network other than the cellular phone SMS network to a measurement recipient user computer system, in parallel with the measurement that is sent over the cellular phone SMS network.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed:

1. A computer-implemented method for establishing a voucher exchange blockchain, comprising:
operating, by a blockchain node, a voucher blockchain datastore storing blocks each having a header with a previous-block hash and a payload;
creating, by the blockchain node, a genesis voucher block whose payload specifies a voucher identifier and a voucher policy including an advisor identifier and a term, and appending the genesis voucher block to the voucher blockchain;
receiving, from a cryptographic key pair server, a public key for a first user and generating a private-key token bound to a user identifier and the public key, the private-key token being signed by the cryptographic key pair server;
receiving, at a voucher server, a first user instruction signed with the first user's private key and verified using the public key, the first user instruction requesting creation of a user account;
generating, by the voucher server, a user-account token comprising an account identifier and the advisor identifier, the user-account token being signed by the voucher server;
appending, by the blockchain node, a user account block whose payload includes the user-account token and a hash of one or more executed account setup documents;
receiving recipient and advisor instructions verified using respective credentials, the recipient instruction requesting redemption and the advisor instruction authorizing account opening;
generating an access-right token comprising a scope granting redemption, a term specifying an account maintenance period, and a signature by the voucher server; and
appending a voucher transfer block whose payload comprises the access-right token and hashes of redemption documents, thereby recording exchange of a voucher to the recipient subject to the term.

2. The computer-implemented method for establishing a voucher exchange blockchain of claim 1 wherein each executed agreement is hashed using a secure hash algorithm and the hash is stored in the payload.

3. The computer-implemented method for establishing a voucher exchange blockchain of claim 1 wherein verification of death comprises validating a digital certificate or received notice from specified accounts before appending a distribution initiation block.

4. The computer-implemented method for establishing a voucher exchange blockchain of claim 1 wherein the voucher blockchain is a permissioned blockchain with validator nodes operated by the voucher server and advisor systems.

5. The computer-implemented method for establishing a voucher exchange blockchain of claim 1 wherein the access-right token includes a reversion condition causing funds to revert upon failure to maintain the account for the term.

6. The computer-implemented method for establishing a voucher exchange blockchain of claim 1 wherein each token comprises: a token type field, a subject identifier, an issuer identifier, a signature algorithm identifier, and a digital signature verifiable against a certificate for the issuing server.

7. The computer-implemented method for establishing a voucher exchange blockchain of claim 1 wherein the payload of each block comprises a Merkle root computed over hashes of included tokens and document hashes, and the header stores the Merkle root.

8. The computer-implemented method for establishing a voucher exchange blockchain of claim 1 wherein complete document bodies are stored in the storage server and only a cryptographic hash of each document is stored in the voucher blockchain payload.

9. The computer-implemented method for establishing a voucher exchange blockchain of claim 1 wherein the voucher blockchain node rejects appending a voucher transfer block unless the recipient instruction and the advisor instruction are both authenticated and time-stamped within a configured validity window.

10. The computer-implemented method for establishing a voucher exchange blockchain of claim 1 wherein the access-right token further comprises a revocation status and a revocation signature binding a revocation reason and time to the token.

11. The computer-implemented method for establishing a voucher exchange blockchain of claim 1 wherein the voucher blockchain is implemented as a permissioned consortium network in which validator nodes are authenticated using mutual TLS and hardware-backed keys.

12. The computer-implemented method for establishing a voucher exchange blockchain of claim 1 wherein the genesis voucher block further specifies a voucher policy identifier referencing advisor identity, recipient eligibility criteria, and term schedule parameters.

13. The computer-implemented method for establishing a voucher exchange blockchain of claim 1 wherein appending the user account block comprises including a hash of a recipient identity verification artifact selected from a notarized ID copy, biometric acceptance, or an e-signature certificate.

14. The computer-implemented method for establishing a voucher exchange blockchain of claim 1 further comprising executing a rule that upon detection that the recipient fails to maintain the account for the term, generates a forfeiture record block and initiates transfer of funds to an estate or trust account designated in the voucher policy.

15. The computer-implemented method for establishing a voucher exchange blockchain of claim 1 wherein the recipient instruction comprises a redemption request signed using the recipient private key and the advisor instruction comprises an account-opening authorization signed using an advisor private key, and both signatures are verified prior to appending the voucher transfer block.

16. The computer-implemented method for establishing a voucher exchange blockchain of claim 1 wherein the voucher blockchain node records a newsfeed notification block for each upcoming required action and each such block includes a timestamp, recipient identifier, and a hash of notice content delivered via email or text.

17. The computer-implemented method for establishing a voucher exchange blockchain of claim 1 wherein the voucher transfer block includes a field indicating an exchange type set to “voucher” to distinguish from distribution and trust exchange types.

18. The computer-implemented method for establishing a voucher exchange blockchain of claim 1 wherein the secure hash algorithm is selected from SHA-256 or SHA-3 and the digital signature is ECDSA over a named curve disclosed in the system configuration.

19. The computer-implemented method for establishing a voucher exchange blockchain of claim 1 wherein the voucher blockchain datastore enforces an append-only property by validating the previous-block hash against a locally persisted chain tip prior to storing the block.
